(19) United States
(12) Patent Application Publication
(10) Pub. No.: US 2020/0160255 A1
(43) Pub. Date: May 21, 2020

(54) TIERED SALARY SYSTEM

(71) Applicant: William Douglas, Prairie Village, KS (US)

(72) Inventor: William Douglas, Prairie Village, KS (US)

(21) Appl. No.: 16/505,652

(22) Filed: Jul. 8, 2019

Related U.S. Application Data
(60) Provisional application No. 62/694,966, filed on Jul. 6, 2018.
(60) Provisional application No. 62/831,841, filed on Apr. 10, 2019.

(51) Int. Cl. G06Q 10/06; A63B 71/06

(52) U.S. Cl. CPC G06Q 10/063118; A63B 71/0616

(57) ABSTRACT

A computerized system and method for generating and filling player or employee rosters within a tiered salary structure via an assignment and selection process using preset salary tiers, team or employer selection criteria, player or employee rank order or preference lists, and a recursive priority algorithm. One party (players, employees) submits preference lists in advance of the matching process. The other party (owners, employers) submits selections in real-time during the selection process via a graphic user interface. Particular embodiments for professional sports leagues include a priority algorithm of highest salary tier, current team status, and higher player preference to assign players to teams. Embodiments of the invention include a tier-by-tier match wherein roster positions in higher salary tiers are selected and filled first, and a comprehensive match wherein roster positions in all salary tiers are selected simultaneously.

### CROSS REFERENCE TO RELATED APPLICATIONS

This application claims the benefit of the prior-filed, co-pending provisional patent applications, Ser. No. 62/694,966, filed Jul. 6, 2018, and Ser. No. 62/831,841, filed Apr. 10, 2019.

### BACKGROUND OF THE INVENTION

### Field of The Invention

The present invention relates to a system and method for determining salaries and player distribution among teams in a professional sports league.

### Background of the Invention

Prior to development of the present-day free agency system in professional sports leagues, many major professional leagues included a reserve clause in player contracts. A reserve clause stated, in general, that a player bound by contract to a league or team was not allowed to negotiate with another team, even after the player's current contract expired. In other words, the player was contractually attached to his team unless the owner released or traded him. If his owner refused to release or trade him, his choices would be to accept the contract offered to him or leave the league, effectively leaving the sport. A player's negotiating leverage was minimized. This situation persisted until the development of competing (alternate) professional leagues. For example, the American Football League (AFL) was formed to compete with the National Football League (NFL), and the American Basketball Association (ABA) was formed to compete with the National Basketball Association (NBA). The reserve clause was likely a primary cause for the formation of these new leagues. Players at the time were grossly underpaid in the traditional leagues in comparison to their true value. The alternate leagues could offer salaries which lured players away from the traditional leagues. The alternate leagues proved that professional athletes had been vastly underpaid.

In 1975, the Supreme Court abolished the reserve clause because it was felt to violate antitrust laws and encouraged collusion by owners. The abolishment of the reserve clause ushered in the era of free agency. The mid-1970's ushered in a new financial and competitive structure: players bargaining for salaries among teams within a professional major sports league, with that league representing a monopoly for that sport. To maintain a league with the highest level of performance, a single league in each sport functions as a monopoly; this has never been seriously questioned. The best players compete against each other for the best level of performance, greatest fan interest, and greatest overall league revenue. Some of those present in the mid-1970's likely predicted what would eventually happen. Individual franchises (teams) would compete for players with higher and higher salaries to field winning teams. Ticket prices would skyrocket. Cities would be required to financially support millionaire (or billionaire) owners to keep franchises in their cities, largely to pay for the vastly increased salaries of players.

By the late 1980's and early 1990's, it was clear the system was no longer keeping pace with the changing sport. Logically, with prized players going to the “highest bidder,” the teams with the most financial resources would retain a systemic advantage. Salary caps, one of the answers to this issue, were applied variably in professional sports. The NFL adopted a “hard cap” (firm salary limit per team); the NBA adopted a “soft cap” (a flexible limit with complex rules and penalties for going over the limit). Major League Baseball, despite bitter disputes, has never been able to adopt a salary cap. However, other measures were adopted to control movement of players from team to team, such as free agency restrictions (limiting free agency to players with a sufficient number of years' experience). Other modifications included franchise tags and various other maneuvers to compensate a team for losing a valuable player to another team. The modifications around free agency are considerable.

These debates and modifications should have prompted a complete review of the structure of salaries and player movement in professional sports. The free agency system began as the default system because there was no comprehensive re-evaluation and consensus on the special requirements of a salary system for a major professional sports league. Indeed, the situation in professional sports is both complex and unique, sufficiently so that it requires a unique structure, custom-made for its many demands. Among the many considerations, the salary structure in professional sports needs to account for the following:
Athletic careers in professional sports are short and unpredictable. It is most fair to pay appropriately in real time so that players are justly compensated.
“Real time” is most practically interpreted as an annual reappraisal. It would be difficult to adjust mid-season.
The market for players in professional leagues does not function appropriately as a competitive free market; alternate methods for determining salaries need to be employed.
Player movement from team to team needs to be structured to retain competitive parity between teams.
Player movement from team to team needs to optimize the quality of play
The relationship of the community/fans and the star players of the team need to be maintained.
Star players need to be paid accordingly for their greater contributions to their teams and to the sport. On the other hand, work effort is similar for all players on the team, and all players contribute to the success of the team. Thus, star players should be paid more than average players, but average players should be paid as if they are vital parts of the team.

Given these challenges, there has been a long-felt but unmet need for a complete overhaul of the free agency system to create a comprehensive restructuring of the system for salaries and distribution of players to adapt to the new rules and new environment. The world of sports has changed dramatically. Revenues and salaries have increased markedly. Despite the passion for professional sports, and the tremendous revenue involved, the system which was left was the default system created when the reserve clause was abolished. To this day, players negotiate with individual teams to bargain for the best salary. The free agency system in professional sports is not absolutely without merit, however, a better system is desired.

Attributes of a Salary System: Equity and Distribution

When free agency suddenly came into existence in the 1970's, players were quickly given multiyear contracts. This phenomenon deserves reflection. One cannot accurately predict how well a player will perform in the upcoming season, let alone for years to come. Despite that, owners were behaving rationally in signing players to multi-year contracts. Unconsciously, they were balancing the 2 principle attributes of a salary system in professional sports: equity and distribution. Understanding these attributes is essential to create a better system.

Equity

Equity refers to the fairness (appropriateness) of money as it is dispersed among players. In a salary cap environment, the total league salary is fixed. Good systems could be described as “fair” or “highly equitable.” Poor systems would be described as “unfair,” “not equitable,” or “poorly equitable.”

The most equitable system needs to balance two opposing philosophies. One philosophy would be to pay each player on the team the exact same salary (“equal pay.”). The equal pay philosophy asserts that all players on a team generally contribute the same effort. They are required to be present for the same practices, the same games, and are expected to work with maximum exertion throughout the season for the common interest of the team. The same effort for the same team deserves the same pay. The opposite philosophy could be termed the “contribution-to-winning” philosophy. This philosophy is what currently dominates the free agency system. Contribution-to-winning states that pay should correlate with the contribution of an individual players contributes towards his team's (winning) success. Contribution-to-winning implies that each team will devote any combination of salaries to whichever player it chooses to assemble the most winning team. The corollary to contribution-to winning is that any player who does not contribute to winning significantly more than the next best player who did not make the league (the last player cut) would get a minimum wage. With fierce competition to obtain a position in the professional leagues, it is not surprising there are relatively few players who have the skill set to make a substantial difference versus the next best alternative. This is true in most sports, where there are consistent champions who separate themselves from the multitudes of “next best” players by a very small but consistent amount.

An analogy can be made to sprinters. World record holder Usain Bolt is a 3-time Olympic Gold Medalist, an international celebrity, and has become very wealthy as a result. He won the last Olympics with a time of 9.81 seconds. The remaining times in the Olympic finals ranged from of 9.89 to 10.06. Despite the great accomplishment of competing in the Olympic finals, none of the other sprinters earn nearly as much fame/fortune as Usain Bolt. Usain Bolt does not run much faster than the other sprinters, but just fast enough to consistently win, even if by a small margin. For comparison, the NCAA 100-meter dash record is 9.82 seconds, and the Texas high school record is 10.13 seconds. By inference, there are many who could run close to 9.90. If sprinting were an 8-man team sport, the very few players who ran close to 9.80 consistently would be making huge amounts of money, but those who typically ran 9.90 could always be replaced; thus those 9.90 sprinters would make only the minimum salary allowed. All would be considered elite sprinters, but that 0.1 second difference is the difference between the sprint team winning and losing. If sprinting were a team sport in a US professional league, Usain Bolt would command a huge salary. Despite the tremendous achievement of sprinting the 100 meters in 9.90 seconds, the other 7 sprinters would make near the minimum salary given the “contribution-to-winning” norm of free agency. All are working hard at practices, meets, and contributing to the necessary team effort. In the NFL, star players make approximately 50 times the salary of a minimum salary player (25 M/year vs. 500 K/year). All players in the NFL are accomplished players; only 9 in 10,000 high school senior football players will be drafted by the NFL. One could argue that the reserve players in the NFL are equivalent to sprinters who run the 100 meters in 9.90 seconds, whereas star NFL players, are equivalent to the sprinters who run the 100 meters in 9.80 seconds. The difference in pay between these two groups of players is astonishing, and one could argue the difference in pay is too great.

There is another conclusion one should draw regarding equity in professional team sports: a salary system which utilizes a “contribution-to-winning” element should pay for performance accurately. In other words, the more accurately teams can predict the quality of a player's play, the more accurately that team can calculate the fair and just salary for that player. This is true whether contribution-to-winning is the sole determinant of a salary or whether it is one of the factors used in determining salary. The corollary is that a system which impedes a team's ability to predict a player's performance makes the contribution-to-winning less accurate and therefore decreases equity. No one would claim to be able to perfectly predict a player's contribution to the team's success for an upcoming season. However, any systematic flaw which decreases teams' ability to predict the quality of a player's performance decreases the estimation of performance and decreases the accuracy in determining appropriate salary for that player. Put even more simply, if you are going to pay better players more, you should do it accurately; otherwise, it will be unfair (decreased equity) to those deserving players who are undervalued and thus underpaid.

If contribution-to-winning should not be the only factor for determining salaries, then there needs to be league-wide control over salary levels. If salary negotiations are left to individual teams negotiating with individual players, a contribution-to-winning model will be utilized, probably exclusively; there is no reason for teams to do otherwise. If a player's contribution-to-winning is not different than the last player cut from the league, the team is incentivized to give that player the minimum salary and use its resources on players whose contribution-to-winning is greater, even if only slightly greater. If league-wide consensus (owners and players) conclude that equal pay philosophy deserves to be a component in determining salaries, then greater league-wide control over salary levels needs to be employed. That league-wide control could take the form of stricter maximum salaries for individual players, increased minimum wage, limited numbers of players at very high or very low salary levels, etc.

A more comprehensive league-control over salaries would take the form of pre-determined salary levels. The owners and players, as a group, could decide what the highest paid player should receive, the lowest paid player, and all in between. This, in fact, is a more familiar system within American industry where most employees obtain jobs that offer a certain pre-set salary or narrow salary range. Professional sports leagues are a form of private American corporation. In the typical American corporation, or government institution as well, employers assign predetermined salaries for particular positions. In some situations, a labor union has input into those salary levels; in some situations, the salary levels are chosen by the employer only. Either way, salaries are predetermined, and prospective employees choose to apply for a job with that given salary. The employer then decides if the prospective employee is suited for the position. There are a certain number of positions at each salary level. The sum of all positions defines the institution's personnel budget. For leagues with a salary cap, the sum of these positions would equal the salary cap, which is already fixed by collective negotiation. Thus, predetermined salaries would change how that sum is divided among the players, not the total sum itself.

Distribution

Distribution is a shortened term for “player distribution,” and refers to how players are allocated to different teams. Distribution must factor many goals. Players should have some opportunity to voice opinions as to where they play. Competitive parity must be maintained among teams in the league. These goals are well recognized in the current free agent system. Important goals, yet currently less well acknowledged, are team chemistry and fan loyalty. The quality of a team's performance is adversely affected when athletic ally-important players suddenly leave a team, presumably for more money. Also adversely affected are the fans of the team who have bonded with the star players. It is an unquantified loss to the league/teams in general when popular and familiar players leave at the peak of their careers for other teams.

A salary system which has ideal distribution qualities would be described as “ordered.” A salary system which has poor distribution qualities is described as “chaotic.” Undoubtedly, subjective opinion will enter the discussion when deciding whether a given salary system is ordered or chaotic. While one could conceive of general agreement when judging attributes separately (e.g., a system is ordered when it is able to keep its star players and chaotic when it's star players randomly leave for another team), it is more difficult to judge when balancing different attributes (e.g., the prerogative of a player to determine where he will play versus the need to maintain competitive parity among the teams).

It would be an oversimplification to state that anything which limits player movement leads to a more ordered distribution. Player movement between teams is necessary for a variety of reasons. It is necessary to maintain parity. It is necessary for teams to improve. Some player movement due to player choice should remain the prerogative of the players themselves. Thus, distribution is a multi-factorial quality which does not have a clearly defined metric. Despite its lack of defined quality endpoints which can be summed on a linear scale, the concept of ordered distribution is vital. The primary purpose of ordered distribution is to make the best game possible. The “best game possible” encompasses the highest athletic performance, parity, and image with fans. Professional sports are not immune to failure. For sure, player preferences should be factored the distribution plan for a professional league. One could make a strong argument that the players' interests are best served by the highest possible success of the league, and player preferences regarding where to play should take a lesser priority.

An even greater issue is balancing equity and distribution. Equity and distribution are often opposing goals in a salary system. The quality of any salary system can, in fact, very much be judged by how well the system balances these two fundamental goals.

Problems with Free Agency

“Players should have the right to test their value in the free market.” The implication of that statement is that a player's rights would be violated if he were not allowed to individually negotiate a salary with the team of his choice. There are at least two direct responses to that concern. The first is that, in general, there is no right to individually negotiate salaries. This is not an issue of fundamental rights typically protected by the government through the Constitution. Negotiating individual salaries has been in practice in professional sports for roughly 40 years. It certainly is not unethical to individually negotiate contracts; however, professional sports leagues are private business entities, and the players are employees. They are not independent contractors. There is no “violation of rights” for an employer to offer a job at a given salary; the prospective employee may accept the salary or seek employment elsewhere. As stated earlier, most US corporations (and government institutions) hire people into preset salaries. Firemen, teachers, machinists, nurses, and janitors are all hired into positions with preset salaries. The same is true for employees that are more highly paid. Most university faculty, physicians, and attorneys who are hired as employees are hired into preset salaries (or narrow salary ranges). There is no right, implied or otherwise, that any of these employees have the fundamental right to individually negotiate for a salary.

There is a second response to the assertion that players should be able to “test their value in the free market.” That assertion is simple: there is no free market. In reality, there are no truly perfect free markets. The “perfect” free market, in economic theory, implies conditions which can never be truly achieved. For a market to be perfect, there must be a large number of consumers and suppliers, with all consumers and suppliers having full knowledge of market prices and quantities.

Most labor markets function closely enough to the free market situation. Teachers, laborers, engineers, nurses, IT technicians, and construction workers all have their salaries determined largely by market forces. Labor shortages will increase wages and encourage entrance into the field. An oversupply in these specific labor markets, and thus a cohort of jobless workers, will force wages to fall and discourage entrance into the field. These forces maintain the equilibrium of the market and determine the price (salary) and quantity of labor. Most of the assumptions of these markets still depend on the idea that most of the labor pool is made up of roughly equivalent workers. Although there are certainly individual workers who stand out, the general wage structure is driven by the general supply vs. demand of workers rather than competition for uniquely qualified individuals.

There are markets for “specialty labor.” Specialty labor, in the context of this manuscript, refers to individuals whose special skills bring compensation which is greater than predicted based on the supply/demand forces of the general pool of labor. This would encompass people who are unusually skilled or well known in their fields. A prominent architect, chef, money manager, physician, attorney, university researcher, or engineer may receive “extraordinary compensation” based on his/her special skills or reputation. In theory, his/her compensation reflects the increased revenue that those special skills bring to the company or institution. This extraordinary compensation does not compel the more ordinary workers to a lower salary. The higher salary is generated from the increased revenue, reputation, or other benefits these uniquely qualified workers bring to the institution/organization. A key difference between typical labor markets and specialty labor markets is that employers have preferences regarding each individual worker in a specialty labor market instead of the large, interchangeable workforce of a typical labor market.

A relevant example of specialty labor in the entertainment industry would be star actors and actresses in major movie productions. Star actors/actresses are often paid enormous sums of money to appear in movies. Although it is possible that many of these entertainers truly act better than lesser known actors (they became famous for a reason), one would have to assume that most of the reason they are paid these very large sums is name recognition with the public. This recognition will make it more likely that people will pay for the movie and thus increase revenues. There is no specific limit of these revenues. The increased amount paid to the famous actor/actress is a direct calculation of the extra revenue expected for that movie. The supporting actors/actresses are not paid differently than if the movie were created with a lesser known actor/actress in a leading role. The supporting actors/actresses would still be paid according to the typical standards of the labor market for movie actors. The “extraordinary compensation” is generated from the extra revenue the movie produces, not decreased wage of the supporting cast.

The Labor Market in Professional Sports

The construct of a professional sports league with a salary cap cannot pretend to resemble anything close to a free market. The number of players hired by the league is predetermined. In adverse circumstances, a team cannot decide to have fewer players. For the most part, the number of players by position is also fixed. An NFL team, for example, needs a certain number of quarterbacks, wide receivers, defensive linemen, etc. There is some flexibility in this area, but not much. A “down year” financially cannot be compensated by hiring fewer players or deciding that the team will forgo expensive quarterbacks for the upcoming year in favor of increased numbers of less expensive tight ends. The supply curve also bears little resemblance to a normal supply curve in a league with a salary cap. In a typical labor market, the supply curve is upward sloping. In other words, as salaries increase, more people are willing to enter that job category. The salary cap fixes the total league salary at a certain level. In theory, the salary cap would keep the salary at the same level regardless of the number of players, making the supply curve horizontal. The amount paid by a team is predetermined. The total team salary and number of players has no real opportunity for movement based on the market forces of supply and demand.

Another reason why the market for professional players should not be considered a free market is that every dollar negotiated by one player is a dollar taken away from other players. In other labor markets, which includes typical labor and specialty labor markets, increased salaries for some employees do not necessarily imply decreased salaries for someone else. Market forces, in fact, largely determine how much is spent in aggregate on total labor for that market. The typical market finds the equilibrium between price and quantity. The product of price and quantity in a labor market is the total salary spent on labor for that market. Labor negotiations in the salary cap environment are different. The total aggregate of money spent on salaries is fixed by collective bargaining between a labor (players') union and the owners. With a fixed aggregate salary, every dollar which is placed in the contract of one player is a dollar less than is available for other players, including those who have yet to negotiate their contract. Players with long-term contracts have money committed to them by their teams long before many of the players have the opportunity for the remaining positions. With a fixed aggregate salary per team and a specified number of players per team, it would be more equitable for all players/parties to be able to negotiate simultaneously.

The Market for Professional Athletes is not a Free Market

The previous section describes why the market for professional athletes is not a free market, justifying why the salary system should not be structured as if it were a free market. In reality, the lack of a free market has already been accepted. Three of the four major professional sports leagues in the United States have a salary cap (Major League Baseball being the exception). Market forces are not adequate to determine equilibrium price and quantity of labor. Professional sports leagues have recognized this and have opted for collective bargaining to determine price and quantity. The existence of the salary cap is the rejection of the free market. This is not a criticism of the salary cap; a salary cap is a logical step in the salary structure of professional sports. The inconsistency is, on one hand, to accept a salary cap; then, on the other hand, advocate individual salary negotiations in the spirit of a “free market.”

Another acknowledgement that the free market has been abandoned are the various free agency restrictions which are present in all major professional leagues. Free agency restrictions are numerous and complex, and a full discussion of free agency restrictions is beyond the scope of this writing. The most basic free agency restrictions mandate that players have a certain number of years of service prior to having the “right” to individual contract negotiations (free agency). A reasonably functioning “free” market wouldn't require such restrictions. Such restrictions only exist because those young players would bring higher salaries if they had the opportunity for free agency. The league must feel that their current team should have the right to retain their services under controlled conditions. There is nothing inherently wrong with this arrangement, but it does verify that the existence of a free market has already been refuted. Other alterations in the market which would be unnecessary include compensation for signing restricted free agents, franchise tags, etc. The ideal system would be an improvement such that it would minimize these alterations.

Equity Vs. Distribution, and the Long-Term Contract

Equity and distribution are frequently opposite features of a salary system. In other words, changes which improve equity are likely to make distribution more chaotic, and the reverse is also true. The challenge is to find the system which balances these goals with the best result. An important corollary of this premise is that many systems can be generated which are reasonable. Some will be more highly equitable in favor of being more chaotic. Some will be more ordered in favor of being less equitable.

When free agency came into being, long-term contracts for highly skilled players quickly became the norm. The arguments in favor of granting players long-term contracts would have been highly persuasive even though no player's performance can be accurately predicted over the length the contract. If single year contracts were utilized in a free agency model, then players would be moving to different teams continuously. Pay-for-performance, and thus equity, would be optimized. A player's worth would be revaluated each year. Players who improved would be compensated accordingly. Players whose performance deteriorated would be forced to accept less money. However, in the understanding of “equity vs. distribution,” multi-year contracts were still beneficial. If equity would be optimized with free agency and single year contracts, then distribution would suffer terribly and become very chaotic. Star players (important both for their athletic contribution and their connection with fans) needed to be kept with their teams. A large number of players would move teams each year to optimize their salaries. Thus, the diminished equity of multi-year contracts was outweighed by the more ordered distribution. In a free agency model, multi-year contracts achieve a better balance of equity and distribution. However, multi-year contracts still have significant drawbacks. These drawbacks have become accepted but should not be considered inevitable. The drawbacks will be elucidated in terms of equity and distribution.

Equity Drawbacks Due to Multi-Year Contracts

Pay for Performance: Multi-year contracts inevitably brings about pay-for-performance issues. As stated earlier, a player's performance cannot be accurately predicted for the next game or the upcoming season, let along several years in advance. If one assumes that players who perform better (more contribution towards a team's success) deserve higher pay, then multi-year contracts diminishes the accuracy of pay-for-performance.

From the player's perspective, it is logical to desire a secure, multi-year contract, as it is logical for anyone to desire a secure future. If a player has enough negotiating leverage, he would likely make it a multi-year contract a necessary condition before signing a contract with a team. From the team's perspective, there is risk that a player's performance may deteriorate unexpectedly over the term of the contract. This concern is generally outweighed by the fear that the team would lose the player to another team and an equivalent replacement could not be found. For the team, the multi-year contract is the lesser problem. In the free agency model, both parties agree to the multi-year arrangement and the contract is put in place. A more ideal situation is if a team can be assured that it can retain their star players without committing years into the future. From the player's perspective, a guaranteed multiyear contract is ideal, but a system which assures that his salary will be maintained at a high level as long as his performance is maintained is a very reasonable proposition.

Certainly, the National Football League is full of examples of players offered long-term contracts who did not fulfill expectations. Colin Kaepernick and Brock Osweiller are merely two recent examples of players paid roughly fifteen million dollars per year, who could not even maintain their starting roles. There is no doubt that many players perform at a lower level than their lucrative contracts would have anticipated. One could mistakenly argue that if these (overpaid) players could bargain for such a lucrative contract, then they should be congratulated in the same way we congratulate someone when a stock they had purchased rises in value more than expected. One could argue that the team made a bad choice and paid for its bad choice. Therefore, no intervention is needed. However, every dollar which went into the pockets of overpaid players comes out of the pockets of the other players. In the very short careers of professional athletes, these players are denied access to some of the limited salary dollars available.

Distribution in Free Agency

Distribution refers to the player movement among teams. To be sure, distribution has a subjective component, more than does equity. Distribution involves balancing several goals, including, in no particular order:
Optimizing team chemistry and performance to achieve the highest quality of play
Maintaining player choice for which team he plays
Preserving relationships between the fan base and their favored players

Distribution suffers with free agency. The sudden movement of players at the peak of their careers is an enormous issue. It is likely not discussed much as a problem which needs to be fixed, since it is felt to be inevitable. Free agency system has become deeply entrenched in American professional sports. From an athletic performance standpoint, it is a hindrance to have key personnel suddenly depart the team at the end of their contracts. Professional sports teams are complex performance units with interlocking parts; they are not random collections of individuals. A terrific power hitting third baseman, but with perhaps limited fielding range, may be compensated by acquiring a subpar hitting shortstop with better than average fielding range. A classic drop-back passer in football would require a pass-blocking oriented offensive line; a scrambling dual-threat quarterback requires an offensive line which moves better downfield. These balances are upset with one of the core players of the team suddenly departs. Perhaps more importantly, the actual relationships (both athletic and personal) between the players are disrupted. Basketball players have a chemistry when performing a pick-and-roll. Quarterbacks and receivers develop a rhythm over time. Players become accustom to the systems employed by teams/coaches. These issues are disrupted when core players suddenly depart.

Free agency with free agency restrictions make the distribution even more chaotic. Free agency restrictions set up a pattern where players reach an inflection point at the peak of their careers. Three to six years after entering the league players become unrestricted free agents. Three to six years is long enough for them to become experienced, prove their worth, and become an integral part of the team. Their value in the free agent market (flawed as that concept may be) soars, leaving the team with the difficulty of keeping them. Professional sports are full of examples of players reaching their prime who left their teams (Kirk Cousins, LeBron James, Giancarlo Stanton). NFL teams have often been able to keep quality quarterbacks that they have drafted, but only at enormous expense. However, they generate salaries upwards of 50 times the league minimum salary and at 20 times the median salary. If these salaries were not paid, then these players would have departed for other teams. This once again demonstrates the tug-of-war between equity and distribution.

The opposite distribution pattern should be prevalent in sports. Teams should be able to maintain their important or “core” players without undue expense. Each team should have the prerogative of keeping those players who are the most important for the athletic productivity of the team and who have the most important relationship with the fan base.

Free Agency Restrictions

One of the perplexing features of free agency are the free agency restrictions. “Free agency restrictions” in this context is used as a generic term for all of the exceptions created to unrestricted free agency. A “restricted free agent” is one of the forms of the broad category of free agency restrictions. Free agency restrictions are products of the flaws of free agency. Free agency restrictions are numerous and difficult to completely grasp. The most straightforward restrictions have to do with required years in the league before a player is eligible for free agency. In the NFL, a player may become an unrestricted free agent at 4 years. An unrestricted free agent may negotiate and sign with whichever team he chooses. Although “typical” free agency restrictions involve limiting the negotiating power of players with limited years of service, there are other types of free agency restrictions. Franchise tags allow teams to keep a very valuable player another year while the team continues negotiations or makes arrangements to be successful without that player. There are, however, numerous other free agency restrictions. The “Larry Bird clause” in the NBA allows a team to go over the salary cap to retain one of its own star players. There are other exceptions and modifications of the salary cap, largely designed to allow teams to keep their superstar players. This both acknowledges the importance of players keeping their star players and the inherent lack of effectiveness of a straightforward free agent model in achieving this.

There is a typical limitation on free agency referred to as being a “restricted free agent.” A restricted free agent is 1-2 years short of having enough years of service to be an unrestricted free agent. A restricted free agent implies that the player may negotiate with other teams, but his current team may retain the player if his current team matches the best offer the restricted free agent obtained elsewhere.

Free agency restrictions, in all their forms, are further evidence that the free market has already been abandoned. In a free market, supply and demand should find a fair price. Why should a player with 1-2 years of experience not be given a fair price for his services? Arguments can be made that a team which drafts a player should be allowed the option to retain him for at least a few years after the draft. That would imply, however, that the player must be underpaid during the few years of the restriction, or the team would be able to retain the player without the restrictions. Those are compelling arguments, but not in a market that at other times tries to allege that it is a free market.

The combination of free agency with free agency restrictions leads to this financial inflection point where players at the height of their careers are prone to leave their team. If they do not leave their team, they may force their team to pay such a huge salary that building a team to complement them becomes difficult.

The free agent payback often results in the very most highly paid players have mediocre productivity as they near the end of the lucrative contracts, which they received at the height of their skills when free agency restrictions were lifted. Talented players bargain for long-term contracts at the height of their career; their salaries will remain high even when their skills are diminishing. This is the free agency paradox.

Free agency has many flaws as a salary system in professional sports. The “structure of contest” in professional sports and the limited parties involved in negotiating the salaries of star players creates a pay scale which is greatly weighed towards the star players. Rank-and-file players have little voice, even in a salary cap environment where total team salary is contractually limited. Long-term contracts are a necessary byproduct of free agency, which creates a systemic disconnect between pay and performance. Free agency restrictions form a perplexing phenomenon in sports. Free agency restrictions exist despite the opinion that professional athletes should exist in a free market. They also create a contractual inflection point in the careers of players, which often cause players to change teams at the peak of their careers.

What is needed is a salary system that addresses these several flaws.

### SUMMARY OF THE INVENTION

An embodiment of a tiered salary system implemented in the field of professional team sports may include the following features:

1. Player salaries predetermined by collective bargaining.

2. Players assigned to teams.

3. More sought-after players receive higher, predetermined salaries.

4. A resulting improved allocation of player salaries.

5. Teams are able to retain core players.

6. Distribution of players to teams via a matching market.

7. Salaries, through the entire pay scale, are predetermined by collective bargaining/negotiation.

8. Salary levels are determined collectively by the owners and the players, rather than by the employer alone.

In an embodiment of a Match according to the present invention:

1. The Match takes place annually and all contracts are for one season.

2. The highest/first tier is matched first. When all first tier positions are filled, the Match proceeds to the second tier, and then on to subsequent tiers, until all of the team positions are filled.

3. When a team offers a player a contract, it cannot be rescinded.

4. Players are obliged to accept the highest tier contract offered to them.

5. If more than one team offers a player a contract at the same tier, and one of the teams is the player's current team, the player must accept the contract from the current team. This allows teams to retain core/key players for purposes of team synchronicity and maintaining fan interest/loyalty.

6. If more than one team offers a player a contract at the same tier, and none of the teams is the player's current team, the player may choose his preferred team.

7. Rookies are all given lowest tier contracts/salaries.

A sequence of a Match according to the present invention may proceed as follows:

Prior to the Match:

1. Each player submits his Rank Order, listing the teams in the league in order of the player's preference. In certain embodiments, this Rank Order may be altered by the players between tiers.

2. Each team creates its own philosophies and algorithms for selecting desired players, though there is no commitment to implementing these algorithms during the Match. These algorithms are created to help the teams make appropriate and timely decisions during the selection process. By selection it is meant an action by a team that identifies a player the team hopes to match.

Using team philosophies and algorithms, each team prepares anticipated choices ahead of time. However, they submit actual selections during the Match. As they match, or fail to match, various players, they can and typically will change subsequent choices. Thus, while teams can prepare anticipated choices ahead of the Match, since the teams make simultaneous elections, these preparations merely guide elections.

The Match proceeds as follows:

3. The Match for Tier One begins and each team submits its initial selection for Tier One.

4. For players selected by more than one team, priority is determined first by whether one of the selecting teams is the player's current team and then by the player's Rank Order. If a player was selected by a lower priority team and then subsequently selected by a higher priority team, a vacancy is recreated on the lower priority team. By vacancy it is meant a player slot or position on a team's tier which is to be filled in the Match. Typically, the number of vacancies on all tiers equals the number of players on a team.

5. If a team develops a vacancy (as described above), such as if a player on a team is prioritized to another team, the team must submit an alternative/replacement player selection within a submission interval.

6. All participating teams in the Match continue to make their selections through the process. Selections are not made in turn but are continuous, with player assignment and availability constantly updated.

7. At a preselected/predetermined time the selection/matching process pauses and there is a Priority Stop. During the Priority Stop, teams have a final opportunity to select any of their current players for vacant positions. During the Priority Stop, teams may only select their current players. The use of a Priority Stop is optional and is not a mandatory feature of the Match process.

8. Following the Priority Stop, the selection/matching process resumes so that any vacant positions may be filled. A player may still move to another team if the player is selected by a team higher on the player's Rank Order. Following the Priority Stop, teams no longer hold any priority as to their current players.

9. When all positions are filled, the Tier One Match is complete and the process continues to completion for the other tiers. The terms Tier One or First Tier may be used interchangeably herein, both denoting the highest tier level in terms of player salary.

A variation of the Match, called a “Comprehensive Match,” is an alternative to the sequence previously described:

In the Comprehensive Match, all tier levels (the entire match) are chosen simultaneously.

In certain embodiments, the tier level constitutes a higher priority than current team status or Rank Order (player preference) status. Thus, a “higher priority” team can select a player away from a “lower priority” team on the same tier. However, the lower priority team can still match the player by choosing that player on a higher tier.

Teams continue to select on all tiers until all vacancies are filled and selections cease.

Implementation

As implemented using a computerized system, computer processor effected processes and methods according to an embodiment of the present invention may include the following:

A team makes selections via a system web portal or front end comprising a graphic user interface (GUI) displayed via a browser window or custom web application. First, the team owner logs into the system via the GUI using one or more certifications unique to that owner and assigned to that owner within the system. Such certifications may include a username and password but may also include biometric or electronic certifications, such as fingerprint reader, magnetic card reader, RFID reader, chip reader, or the like, as known in the prior art for certifying a user to a computer or computer system. After certification, the owner may then continue to interact with the system GUI to enter information requisite for the system to generate a Match such as the team's ranked list of desired players.

A player may also interact with the system via the same GUI web interface or application, or a different front end platform, i.e. either a player-specific starting interface, or an initial interface also used by the team owner that takes the player to a different, player-specific, interactive web or application page once the player enters their credentials. The player may interact with the system GUI to make selections of his preferred teams and to submit his Ranked Order.

The Match then proceeds, as described above, with the system storing match data on one or more system servers, and providing match results via the system GUI, as matching proceeds through the tiers. Data stored in the system database or databases includes relatively static data such as player and team identifiers or identification data, and tiers and corresponding salary levels. Stored data also includes dynamic data such as team and player rankings and team and tier player assignments. During, and at the conclusion of the Match process, teams and players may further interact with the GUI to view results of the Match.

An embodiment of the present invention may comprise a method of implementing a computerized matching system for assignment of players to teams within a professional sports league. The method may include the steps of:
a. providing league comprising a plurality of teams and a plurality of players;
b. providing a hierarchical tiered salary structure, with predetermined salaries for each tier and predetermined numbers of players at each tier;
c. a player submitting to a computerized match system, via a player computerized system interface, a rank order of teams in a league in order of the player's preference;
d. a team submitting an initial selection of players for a first tier to the computerized match system via the team computerized system interface;
e. the computerized match system prioritizing a match between a selected player and a selecting team based upon criteria comprising:
whether the selected player is a member of the selecting team, and
the rank position of the team within the selected player's rank order;
f. the computerized match system moving a player from a first matched team to a subsequently selecting higher ranked team upon the higher ranked team's selection of the player;
g. the first matched team submitting an alternate player via the team computerized system interface to fill the team position vacancy created by the player movement to a higher ranked team; and
h. repeating steps c through g for each team in the league until all first tier team positions are filled.

The method may further include the steps of the computerized match system providing a first time interval for performing certain of the above steps; the computerized match system providing a subsequent second time interval comprising a priority stop interval; selection by a team, via the team computerized system interface, of any desired current players of the team during the priority stop interval to fill any of the team's vacant team positions; and the computerized match system removing team priority selection status as to any unselected team players.

The method may further include the steps of a team submitting, via the team computerized system interface, an initial selection of players for a subsequent tier; and repeating certain steps until all such subsequent tier team positions are filled. In certain embodiments, the players may reorder their rank order of teams in between each tier selection via the player computerized system interface. In certain embodiments, the computerized match system comprises a central server accessible over the Internet, or over an intranet, by player and team computerized system interfaces, the computerized system interfaces comprising web interfaces. In certain embodiments, a portion of the total funds available for allocation by a team to fund player salaries at each tier is set aside to fund a superstar bonus for payment to highest valued tier one players in addition to tier one salaries.

It should be appreciated that any team names used herein are for exemplary purposes only and no association is claimed between the applicant and any team or related organization. All player names used herein are fictitious and not intended to resemble those of any individual living or deceased.

Other advantages of the invention will become apparent from the following description taken in connection with the accompanying drawings, wherein is set forth by way of illustration and example several embodiments of the present invention.

### BRIEF DESCRIPTION OF THE DRAWINGS

FIG. 1 is a diagram illustrating an overview of the process whereby players are assigned to teams.

FIG. 2 is a diagram illustrating an overview of the match process.

FIG. 3 is a diagram illustrating an overview of the process by which team vacancies in a tier are filled.

FIG. 4 is a diagram illustrating aspects of an embodiment of the invention operated on a computer system.

FIG. 5 is a series of tables representative of database contents for athlete data, team data, tier data, athlete preference data, team tier data, and match result data.

FIG. 6 is a drawing of a system graphic user interface for use by a player to rank desired teams in order of preference.

FIG. 7 is a diagram of a graphic user interface used by a team to perform a tier-by-tier Match.

FIG. 8 is a diagram of a graphic user interface used by a team to perform a comprehensive Match.

FIG. 9 is a drawing of a system graphic user interface for use by a team owner to show Match results by tier, tier salary and players matched within each tier.

FIG. 10 is a drawing of a system graphic user interface for use by a player to show Match results for that specific player, including team, tier and player salary.

### DETAILED DESCRIPTION

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Various factors are to be considered in a matching market system in professional sports in order to yield a successful system, including:

1. Teams are built by players of different positions. This is fundamentally different from a situation wherein each person is part of only one category and is essentially interchangeable in terms of the slot he/she fills in the larger group (team, institution). Teams consist of quarterbacks, guards, relief pitchers, linebackers, etc. These are not interchangeable parts, and the matching system must allow for teams to select the correct proportion of each.

a. Not only do teams have players of different positions, but some players complement each other differently. A quarterback who throws an exceptionally good long pass may need a speedy wide receiver for the deep routes. A quarterback who is an accurate short passer may have more need for a receiver out of the backfield. A quarterback who runs well may need an offensive guard who can pull and go downfield to block. A quarterback who is a good passer but not very mobile may need an exceptionally good left tackle. Thus, not only are positions different from each other, but the team needs to be built around the specific talents of each of the players.

2. Teams need the opportunity to match virtually any player in the league available. This is a challenging aspect of the matching system. Each year, there are 1696 players who finish the year in the National Football League (53 players/team, 32 teams). Although there are some retirements, there are many more players to be considered in the form of rookies, practice squad members from the prior year, hopeful walk-ons, and players who were injured and now recovered. For the matching system to be successful, it must allow the opportunity to select virtually all of the 2000+ available players. It would be a severe drawback if a team could try to select for 2 quarterbacks preferable to the team's current quarterback before needing to reselect or lose the current quarterback. If there were 30+ quarterbacks that the team preferred, the team should have the opportunity to select any of those quarterbacks and still retain the possibility of their current quarterback. [Note: “Select” does not imply match. “Select” implies the preference of the team and a potential match if the algorithm favors that team.]

3. It is accepted that the players should not be paid the same salary. Although it can be debated how the pay scale should be proportioned, it is unlikely that anyone would seriously argue that everyone should be the same. A successful matching market system for professional sports needs to proportion the pay scale so that all of the players, from the highest paid to the lowest paid, receive appropriate compensation.

4. The movement of players from team to team needs to be balanced to achieve several goals.

a. The quality of the game needs to be optimized. Since players and coaches develop rhythms over years, the flow of players from team to team needs to be controlled so the quality of team play is the best that can be achieved.

b. The relationship of the players with the fan base needs to be maintained.

Thus, players, especially the “star” players with whom the fans identify should not move excessively.

c. Players should maintain the prerogative regarding which team/city whenever possible. Clearly, a player cannot have infinite choice while player movement among teams is also controlled, but as much choice as possible should be retained by the players.

The Tiered Salary System

“Free market” conditions in professional team sports are highly altered and unsuitable to determine salaries and distribution of players. The concept of the Tiered Salary Structure relates most closely to three principles:

1. Salaries should be predetermined: In the current free agent system, teams select desired players, and the two parties meet to consider an agreement. Salaries are then negotiated. This process should be reversed. Salaries should be predetermined via collective bargaining. Players are then assigned to teams by a selection process with the more sought-after players obtaining the higher, predetermined salaries. This will create a better allocation of the players' wages. Currently, the salaries of the highest paid players are determined by a very small number of participants (player, agent, a few team executives) who commit large sums of money many years in advance. The salaries of these star players dominate the shape of the salary curve. This creates very little opportunity for the majority of interested parties, particularly the rank-and-file players, to participate in the salary process. Predetermined salary levels can ensure that all players, from the most valuable to the most expendable, receive the appropriate relative salaries.

2. Teams should have the opportunity to keep their core players: Both for optimal athletic performance and the relationship of the players with the fan base, the ideal salary system would allow teams to reliably keep their “core” or most important players. Because it is necessary to keep an entire core group of players, the top salary must be organized on a level or tier. Similarly, it is ideal to retain different levels of supporting players, creating an entire salary structure of levels, or tiers.

3. Players should be distributed to teams in a matching market: Free market principles do not apply well to the labor market in professional team sports. Teams have strong preferences about which players join the team. These preferences are rational and appropriate, but are not in accordance with the necessary conditions for a well-functioning free market. In addition, there a discrete number of parties (players, teams) on both sides. The better mechanism to best distribute players among the teams under these circumstances is a matching market.

The tiered salary system is a refinement of the above principles. The tiered salary system calls for salaries, throughout the entire pay scale, to be predetermined by collective negotiation. This, in fact, is a more familiar system within American industry where most employees obtain jobs that offer a certain pre-set salary or salary range. In the typical American corporate or government job, employers assign a narrow compensation range for a particular position. A prospective employee chooses to apply for a job at that given salary. The employer then decides if the prospective employee is suited for the position. The tiered salary system works similarly, with some slight differences. The salary levels are determined collectively by the owners and the players, rather than by the employer alone. The employer (team) then identifies the employee (player) best suited to fit into that salary position. Even though there are some differences, the idea of being hired into a preset salary should be viewed as familiar and accepted in American industry, not an elimination of one's fundamental rights.

The tiered salary system also employs one of the principles accepted in restricted free agency: site neutral salary maximization. In restricted free agency, the player has the opportunity to bargain for the highest possible salary. The player's team, however, has the option of retaining that player if the team is willing to match the other team's (higher) offer. The overall system (league, owners, fans) benefits from constraints placed on player movement. The system, however, does not mandate that players accept a lower salary; the salary for each player is always optimized. This concept is also used in the tiered salary system, where a player's salary is always maximized, except as a rookie, though the player does have constraints regarding which team for which he will play.

Organization into Tiers

Salaries are organized into levels, or tiers, for two related reasons. The first reason is that it allows teams to keep the entire group of “core” players. It is a fundamental premise of this salary system that a team be able to retain the core of its team, both to optimize performance and to allow its star players to maintain a relationship with the fan base. The number of players which represents the core is certainly negotiable, although 8 players for football, 5 players for baseball, and 3 players for basketball are likely numbers. It becomes impossible for teams to retain the entire core without paying each of those players the same salary. Thus, the highest salary is not a single position but a group of positions. Once the highest group of salaries becomes arranged as a group as a tier, it becomes advantageous to arrange all the salary levels as tiers for essentially the same reason.

The creation of tiers also limits the need for players to move between teams; this applies to players throughout the pay scale. A player has no reason to move teams unless his skills are valued with sufficient difference that another team is willing to offer him a higher tier contract. Most players will likely settle into a plateau from the standpoint of athletic production or value. Their value will generally be optimized by staying with the same team, as each player has the most familiarity with the players and the coaching system on that team. When that player is on his athletic plateau, there should be little reason for the player to change teams. There will be some player movement. A team may acquire a more talented player at that position, making a good player at his athletic plateau expendable. A team may decide to go in a different direction from an athletic strategy or philosophy. However, the tier system will keep player movement more ordered.

There would be a temptation to identify a small number of “superstar” players who deserve a higher salary than the rest of the core Tier One players. It can be argued quite successfully that bona fide stars (e.g., an All-Pro quarterback) deserve higher salaries than the 7th or 8th best player on a team. The Tiered Salary System, at first glance, would pay the best player in the NFL the same as the 256th best player (assuming 8 players on Tier One multiplied by 32 teams). However, it becomes unrealistic to resolve this dilemma by identifying for 2 players in the preseason who deserve a higher salary than the rest of the core group. If the entire group of 8 players are selected together, it becomes difficult to decide which 1-2 players deserve a higher salary and what that higher salary would be. With the players selected and retained together, there is no motivation to pay for 2 of them more. In reality, the true stars should be paid more and can be paid more, though this adjustment is done at the end of the season as an incentive strategy. This is further discussed in the section on the “Superstar Bonus.”

As with salary systems in general, there is a trade-off between equity and distribution when considering the number of tiers. Equity is improved with greater numbers of tiers. The more tiers, the more accurately the salary can match an individual player. A tier with 10 players would have more of a mismatch between true player value and salary at either end of the tier than would a tier of 5 players. In theory, a tier of 1 player would match salary and player value perfectly. However, smaller tiers would result in more player movement from year to year, resulting in a more chaotic distribution. Players move teams when the value of that player on his current team becomes lower than his value on a different team. That phenomenon would happen more readily with smaller tiers than with larger ones. Thus, equity and distribution need to be matched for the optimal sized tiers. It is important to realize that the size of each tier does not need to be the same. Also, the number of tiers and size of each tier can change from year to year, so it does not need to be considered a fixed value. The match itself would also be unaffected if a league decided to change the number or size of tiers between seasons. The only parameter that matters in the match is identifying a player's current team, which would be unaffected by changing number/size of tiers.

There are some philosophical guidelines which can be used to create the number and size of tiers. Tier One (the highest tier) contains the aforementioned “core” group of players. The second tier would likely represent the majority of starters not in the first tier. The third tier should be the remaining starters and important role players. The fourth tier would consist of regular substitutes, and the fifth tier would be largely reserves. Different sports can have different number of tiers, largely depending on roster size. A baseball team may have 5 tiers of 5 players each. Basketball teams would likely have 3 or 4 tiers with 3 or 4 players in each tier. Football, because of the larger number of players may have 5-7 tiers.

Each team in a professional sports league would have the same tier structure and the same salary at each tier. Thus, the salary burden for each team would be identical, as is already true for leagues with salary caps. Players are allocated to each team annually according to an allocation process. To distinguish this from the amateur draft, this allocation process will be referred as the Match. The Match dictates that all players undergo a selection process in the off-season, with the player assigned to the team which offers the player the highest possible salary. The Match takes place at a convention (a physical place or a virtual convention) with each team listing its choices in rounds as the players eventually get selected.

In an embodiment of a match according to the present invention:

1. The Match takes place annually; all contracts are for one season.

2. The highest tier is matched first. When all of the positions are filled, the Match can proceed to the second and subsequent tiers until all of the positions on the teams are filled. The highest tier is referred to as Tier One.

3. When a team offers a player a contract, it cannot be rescinded.

4. Players are obliged to accept the highest tier contract offered to them.

5. If more than one team offers a player a contract at the same tier and one of the teams is the player's current team, the player must accept the contract from his current team. The “current team” is defined as the team for which the player played during the season which just concluded.

6. If more than one team offers a player a contract at the same tier and none of the teams is his current team, the player may select his preferred team.

7. Rookies are all given lowest tier contracts.

Matching Process

The matching process is designed to allow teams the opportunity to offer contracts to numerous top players while retaining the option of keeping their own players. The Match is conducted tier-by-tier; the process described below is repeated for each tier.

A brief glossary of terms:
Select (selection): An action by a team which identifies a player the team hopes to match
Assign (assignment): Implies a “temporary match.” A player “assigned” to a team within the matching process may eventually match with that team or may be prioritized away to another team.
Match: Implies a permanent assignment of a player to a team (“permanent” meaning for the upcoming season).
Rank Order: A list of teams generated by each player which lists all of the teams in his order of preference
Current team: The team for whom a player played in the season which just ended.
Prioritize/prioritize away: When a player has been selected and assigned to a team, but is subsequently selected by a higher priority team. The player is removed from the lower priority team and reassigned to the higher priority team.

The sequence of a Match according to the present invention may be as follows:

1. Prior to the Match for Tier One, each player submits his Rank Order, listing the teams in the league in order of his preference. It is by mutual decision between the players and the league whether this can be altered in between tiers.

2. Teams create their own lists and algorithms for their desired players in advance of the tier selection.

3. At time zero, the Match for Tier One begins. Each team must submit its initial selection for Tier One.

a. There is no need for a team to be realistic about the odds of matching these players. A team's selections can constitute the very best players in the entire league.

4. In certain embodiments, for players selected by more than one team, the priority system described above is utilized:

a. Current teams hold highest priority

b. If the player is selected by more than one team, and one of the teams is not the player's current team, the Rank Order (determined by the player) will determine the priority among the teams who selected the player.

c. Since a contract cannot be rescinded and the current team holds the highest priority, players matched to their current team can no longer undergo any movement in the matching process. They are effectively “locked in” with their current team. Thus, they can be removed from the list of players available for other teams.

5. If a team develops a vacancy (a player assigned to that team is prioritized to another team), the team must submit a subsequent choice within a short period of time called the submission interval. The length of the submission interval is by consensus between owners and players. Teams may make choices much more rapidly than the submission interval; the submission interval is the maximum time in between choices. A team may make choices very rapidly and make dozens or hundreds of choices in the early part of the tier selection.

6. All teams continue to make choices throughout the process. They do not take turns with other teams, so there are continuous, on-going selections during the Match.

a. Players who are available or unavailable to select are constantly updated. Players unavailable to select have already been chosen by teams with a higher priority.

The length of time to complete the selection for each tier can be at the preference of the league. The length of time does not need to be the same for each tier and does not need to stay the same length from year-to-year. There can also be breaks inserted into the process to allow teams to reconfigure their algorithms given the selections which have just taken place.

7. There is an option to limit the length of time for selection, although this is generally discouraged. If it is desired, at a preselected time point the selection process temporarily ceases. At this point, teams have a final opportunity to select any of their current players for vacant positions. This is called the Priority Stop. During the priority stop, teams may only select their current players to fill vacant positions.

8. After the Priority Stop, the matching process resumes for any open positions. Players may still move teams if selected by a team higher on his Rank Order. However, teams no longer hold any priority for their current players.

9. When all positions are filled, the Tier One match is complete.

10. The process is completed for the second and all subsequent tiers.

Table 2 shows a timeline for the matching process within each tier. This process is repeated for each tier.

Table 2

The Match: The Anti-Gaming Structure and the Timed Rounding Process

The timed rounding process and how it impacts a team's selections: The ideal matching process would allow all parties the freedom to make the choices in accordance with their true preferences. In the terminology of matching markets, this is referred to as a safe market. The opposite characteristic would require teams to sacrifice their true preferences for fear of becoming worse off. In other words, there should be no fear or consequence of making selections not in according to one's true choice. The timed rounding process allows a virtually limitless number of choices to be made. The alternative of the timed format would be to have discrete rounds of selections, similar to the amateur draft that occurs in most leagues. (Note that the discrete selections process may work well for the amateur draft.) Discrete rounding would imply that each team takes turns making choices. The result of each choice is allowed to become clear, and then the choices continue in turn. In a discrete rounding process, it would be difficult for a team to make all of the selections it truly wants without making unwanted sacrifices. For example, imagine an NFL team with the 15th best quarterback in the NFL. Although certainly not an All-Star, the 15th best quarterback in the NFL would qualify as a solid player, and it is unlikely that the team could do better since the teams with the 14 better quarterbacks would likely retain their quarterbacks. In the timed rounding process, the team with the 15th best quarterback can select all of the 14 better quarterbacks in the league. It is unlikely that it will actually match any of the 14, as they will likely be prioritized to their current teams. However, the team with the 15th best quarterback can still select the 14 better quarterbacks, and potentially match them, should their current teams not retain them. The team with the 15th best quarterback then can still retain its quarterback. The team lost nothing by trying to select the other 14 quarterbacks.

In a discrete rounding process, the team with the 15th best quarterback would almost certainly not have the opportunity to select the 14 better quarterbacks. The team would have gone through 15 sets of rounds of selections just to settle the quarterback situation. 15 rounds was just an arbitrary example; it could be 30+ rounds to a position. A discrete rounding process would have to allow each team to make one selection at a time. In other words, if a team had 6 vacancies left in its tier, it would make a single selection to fill a single spot on the tier, not 6 selections to fill each of the vacancies. This is true since each selection and assignment (or match) affects the other preferences within that tier. If a team takes 15+ rounds just to fill one position in the match, a discrete rounding process may take hundreds of selections per team to settle the tier. This would be very cumbersome and not realistic.

It is also important to fully clarify the different demands for a matching market for professional sports versus most typical matching markets, such as the National Residency Matching Program. As in most matching markets, the programs/institutions that participate in the NRMP have candidates and positions that are interchangeable parts. For example, a residency might have 100 potential candidates for 10 positions. The residency can rank their 100 candidates in order of preference. The better candidates who match for that residency does not impact their future choices. Whether the residency program's highest-ranking match is the 1st, 2nd, 5th, or 10th choice does not impact the fact that their 40^{th} choice is preferred over their 41st choice, who is preferred over their 50th choice. The situation in professional sports is different. Each match shapes the team and might change a team's preferences. A team may fail to match a defensive lineman (e.g., 5th choice), who is a great pass rusher, but match a different defensive lineman whose best skill is run defense (10th choice). This may mandate selecting a linebacker who is a good pass rusher to complement the match on the defensive line. The linebacker selections may need to change to reflect the matching of the linemen. The timed rounding process has greater efficiency than discrete rounding to make large number of choices to better mold a team during the selection process. A team has the opportunity to select hundreds of players per tier to find the very best player with which to form the best possible team. There is no term which has been created to distinguish a matching process where the preferences are or are not dependent on the matches earlier in the process. In order to define this, a matching system where the preferences are independence of each other, e.g., the NRMP, will be termed “independent selections.” A matching system where the matches earlier in the process may alter preferences will be called “dependent selections.”

A match with dependent selections is what truly separates the matching in professional sports from other matching markets. It may also explain one of the reasons why a matching system has not been previously developed. Previous matching systems with far fewer demands, such as the NRMP, still took years to develop and be accepted. A matching system with dependent selections has not previously been utilized on a large scale. This issue, combined with the need for requiring different salary levels provides a compelling explanation for why this system has not previously been developed.

Rookies

In a typical embodiment of the present invention, rookies receive the lowest tier contract. The Match would necessarily take place after the amateur draft. Any undrafted rookies would have to qualify for the Match by being nominated by a team during the combines. Prior to the Match, all rookies would fill out a Rank Order, as do the veteran players. No rookie would be selected during any round except the last round. Any team may select any rookie during the selection round of the last (lowest) tier. However, the team which drafts a rookie in the amateur draft has priority over other teams selecting that rookie. This is identical to the priority “current teams” have with veteran players. Teams, however, may choose not to offer a contract to a rookie they selected in the amateur draft. If the team which drafts the rookie does not select that rookie in the Match, the rookie can be selected and be matched to another team. If several teams select the rookie and none is the team which drafted him, he will be matched to the team which is highest on his Rank Order.

The Tiered Salary System emphasizes the importance of accurate pay-for-performance in real time. One could argue that highly valued rookies deserve more than the lowest tier contract. The rationale for the method described above is the best balance between two opposing strategies. One strategy would be to allow the rookie to be matched to any tier. If a team really feels a rookie is going to be a star player in the league from the beginning, that team could offer that rookie as high as a Tier One contract. However, offering rookies high tier contracts means that a veteran player would be denied a contract in that tier for a rookie who is untested within the league. It also represents a risk for a team to offer a rookie a high tier contract. Obtaining highly prized rookies can become a controlled form of gambling. Teams which have little likelihood of entering the playoffs for the upcoming season may even decide to clear their veterans from the top couple of tiers and give the contracts to rookies. In this way, they might Match almost most of the best rookies for that year as other teams might be more inclined to offer them Tier 3-4 contracts. This might set them up for success in the future but at an uncertain risk. This introduces a whole gambling mentality to selecting rookies, which adds a chaotic element to player distribution. It also would make it very difficult for teams with current playoff aspirations to match rookies, as they would be given higher tier contracts by those teams who are rebuilding.

The opposite strategy is what is currently utilized. Rookies have the opportunity to negotiate with other teams for several years after entrance to the league. This is effectively like a temporary “reserve clause” which was the norm for all players prior to 1975. As of this time, rookies have to serve in the league 3-5 years before this restriction ends.

The best option may be to assign all rookies to the lowest tier for one year. This practice does not deny them the opportunity for accurate pay-for-performance for one year. However, it means that teams can select them without trying to predict their true impact. Rookies get one year to prove their value and for teams to assess their value. After that, they can be offered a contract at any tier. Truly valuable rookies can expect Tier One contracts for their second season.

Although the pay-for-performance may lack some accuracy during the rookie season, this still represents a significant improvement over the current free agent model, where free agency restrictions limit negotiation leverage for younger players for 3-5 years after entrance into the league. Presently, rookie contracts for high draft picks may receive a higher salary than the lowest tier in the Tiered Salary System, however, better younger players in the Tiered Salary system can outstrip the earnings of typical younger players during the years of free agency restrictions.

The Annual Convention: The annual selection of players, i.e. a Match according to the present invention, could be a great source of enthusiasm and entertainment for sports fans. It would supersede the interest generated currently from the amateur draft and free agent signings combined. In certain embodiments of the invention, the Match process would proceed as follows:

1. Amateur Draft: The player registration would take place after the amateur draft, so the results of the amateur draft can be incorporated into the list of the players registered for the Match.

2. Player Registration: In order for teams to select players, there must be an identified list of players available for the Match. Players must register; i.e., declaring that they wish to play the upcoming season. Players must qualify for registration and can qualify in one of several ways.

The criteria below are given as an approximation; the exact criteria can easily be modified to the wishes of all the players and teams of any league:

a. Any player who has played in the league during the past season or the season before can register.

b. A finishing college player who has been selected in the amateur draft.

c. Any player nominated by a team after the combine.

3. Combine: A combine (or series of combines) would be held for two purposes. Players who do not otherwise qualify for the Match by the first two reasons above can be nominated by a team impressed with their performance. The combine can also allow teams to better familiarize themselves with the players in anticipation of the Match. The combine would not be mandatory for all players. Many players would be sufficiently well known throughout the league that this would be unnecessary. However, lesser known players can be made familiar to various teams to make their selection more feasible during the Match.

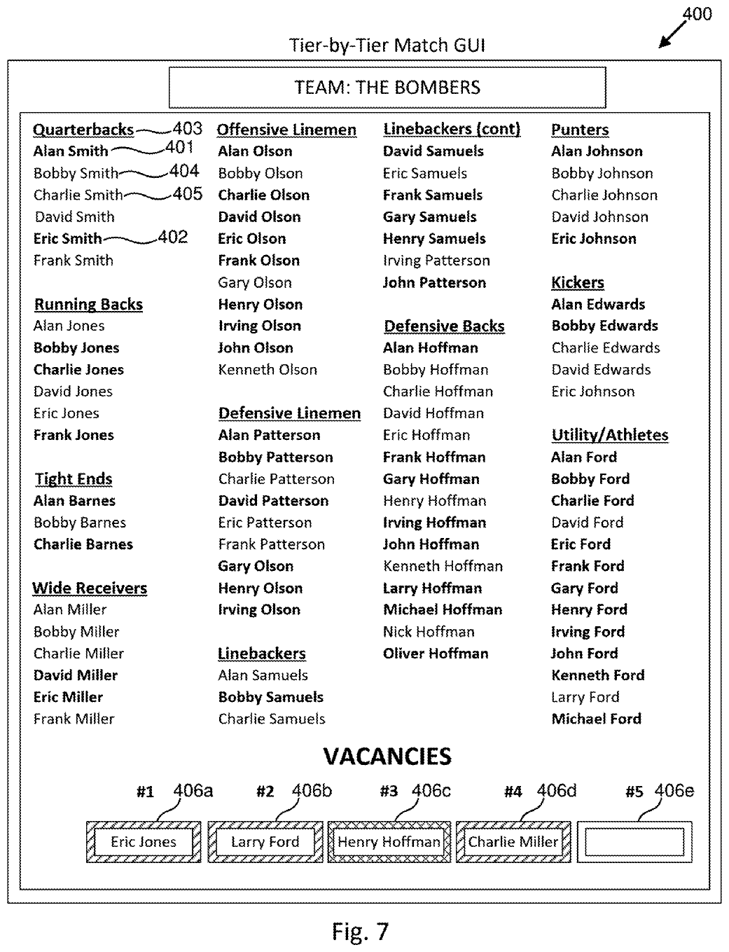

4. The Convention: The convention (or whatever name the league wishes to apply to it) is the Match itself. The convention can take place over for more days. The Match can take place at a single physical location, or it can be a virtual convention. Either way, the Match is a computer mediated process. All of the players submit their rank order prior to the matching process for that round, and teams all have the list of names. In certain embodiments, each player name is color-coded on the teams' computer screens to reflect their status (see FIG. 7):

a. Green: Players available to be selected.

b. Red: Players not available to be selected.

c. Blue: Players selected but not yet matched, in other words, players assigned to a team (i.e. temporarily assigned but not matched or “locked”).

d. Gold: Players matched and “locked” to a team.

The vacancies for each team are readily visible on their computer screen.

The “green” status does not differentiate between players who have not been selected by any team versus players who have been selected but to a lower priority team. For the purposes of the Match, it is not essential for a team to know whether a given player has assigned; it is only essential for a team to know whether it is available for it to select.

An exemplary team web interface/GUI 400 for performing a tier-by-tier Match is illustrated in FIG. 7. This is an exemplary computer screen display viewed by a team (e.g. “The Bombers”) showing players that are available, unavailable, temporarily assigned and matched. This figure is not specific for tier level. In certain embodiments, players that are available for selection by the team are shown in green lettering, represented in FIG. 7 by player names listed under team positions and in bold (e.g. Alan Smith 401 and Eric Smith 402 under Quarterbacks 403). In this example, the team would not know whether an available player had not yet been selected by any team or had been selected by a lower priority team, thereby remaining available. Players that are unavailable for selection may be shown in red lettering, represented in FIG. 7 by player names listed under team positions that are not in bold (e.g. Bobby Smith 404 and Charlie Smith 405 under Quarterbacks 403). In this example, there are five player vacancy positions 406a-e. Players Eric Jones, Larry Ford and Charlie Miller have all been selected and temporarily assigned (but not yet finally matched) to the team as indicated by the diagonal line patterns in boxes 406a, 406b, and 406d, which in this example represents the color blue. Player Henry Hoffman has not only been selected but has also been matched to the team, as indicated by the cross-hatch pattern in box 406c, which in this example represents the color gold. In this example, no player has been selected yet for the fifth vacancy, as indicated by the lack of player name or color designation in box 406e.

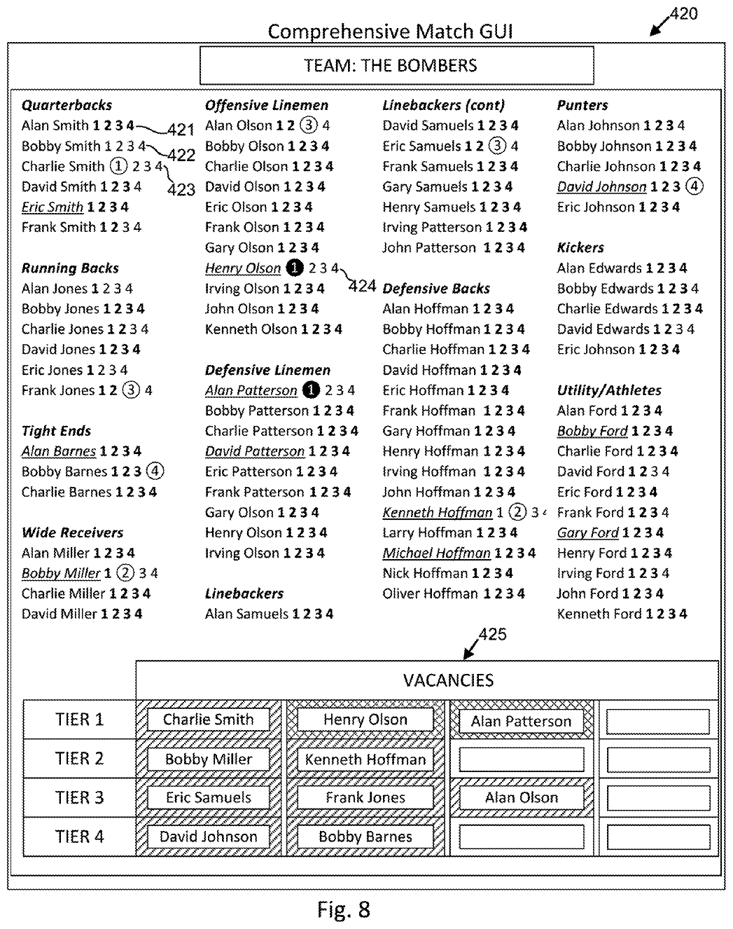

An exemplary team web interface/GUI 420 for performing a comprehensive Match is illustrated in FIG. 8. In this figure, player availability or unavailability is indicated on a tier basis thusly: Tier numbers in bold (such as all four tier numbers 421 to the right of the name Alan Smith) indicate that a player is available for selection to that tier. In certain embodiments, these numbers would be color-coded, e.g. shown in green numerals. Tier numbers not in bold (such as all four numbers 422 to the right of the name Bobby Smith) indicate that a layer is unavailable for selection to that tier. In certain embodiments, these numbers would be color-coded, e.g. shown in red numerals. Similarly, numbers in blue or in an open circle (e.g. the tier 1 number to the right of the name Charlie Smith 423) indicate that a player has been selected and temporarily assigned to the selecting team (“The Bombers”), and numbers in gold or in darkened circles (e.g. the tier 1 number to the right of the name Henry Olson) indicate that a player has been matched to the selecting team at that tier. Note that tier numbers 2, 3 and 4 for Henry Olson 424 are not in bold indicating that this player is now unavailable at those remaining tiers (the highest tier 1 already being matched).

A vacancy box 425 shows the names of players that have been selected or matched during the comprehensive match. Players Charlie Smith, Bobby Miller, Eric Samuels, David Johnson, Kenneth Hoffman, Frank Jones, Bobby Barnes and Alan Olson have all been selected and temporarily assigned (but not yet finally matched) to the team as indicated by the diagonal line patterns in their corresponding boxes, which in this example represent the color blue. Players Henry Olson and Alan Patterson have not only been selected but have also been matched to the team, as indicated by the cross-hatch patterns their boxes, which in this example represent the color gold. In this example, no player has been selected yet for remaining vacancies as indicated by the empty remaining boxes. Players who are current team members of The Bombers are indicated by underlining their names. It should be appreciated that many color codes, fonts, symbols and the like could be used in a graphic user interface to convey player status and other information.

To further illustrate, imagine that a player named John Smith played for the Tigers last season. In his Rank Order, he lists Lions, Tigers, and Bears, in that order of preference, if the Bears select Smith, he becomes Blue for the Bears since Smith could still be prioritized away. He is still green for the Lions and Tigers since they both have higher priority than the Bears. If the Lions select Smith later in the round, Smith will turn from Blue to Red for the Bears since the Lions have a higher priority than the Bears per Smith's rank order. He turns from green to blue for the Lions since he is now assigned to the Lions. He remains green for the Tigers since the Tigers have the highest priority for Smith as his current team. If the Tigers then choose Smith, he becomes Red for the Lions and Bears and Gold for the Tigers, since he is becomes definitively matched to the Tigers (current team). On the other hand, if the Tigers never selected Smith, Smith would turn from blue to gold for the Lions when the Tigers' tier becomes complete and no longer has the possibility of selecting Smith.

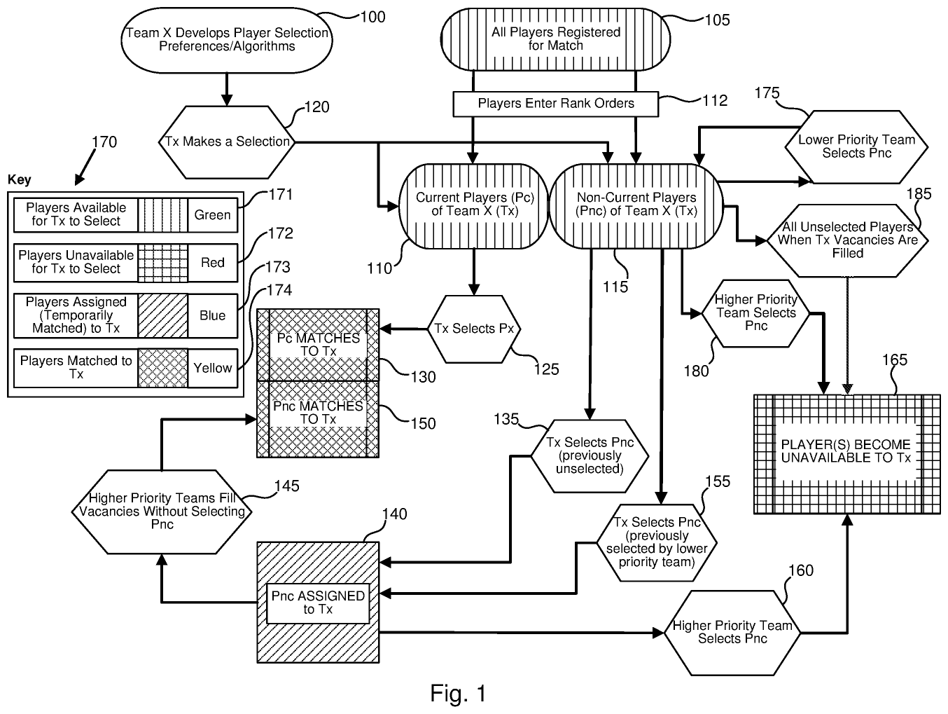

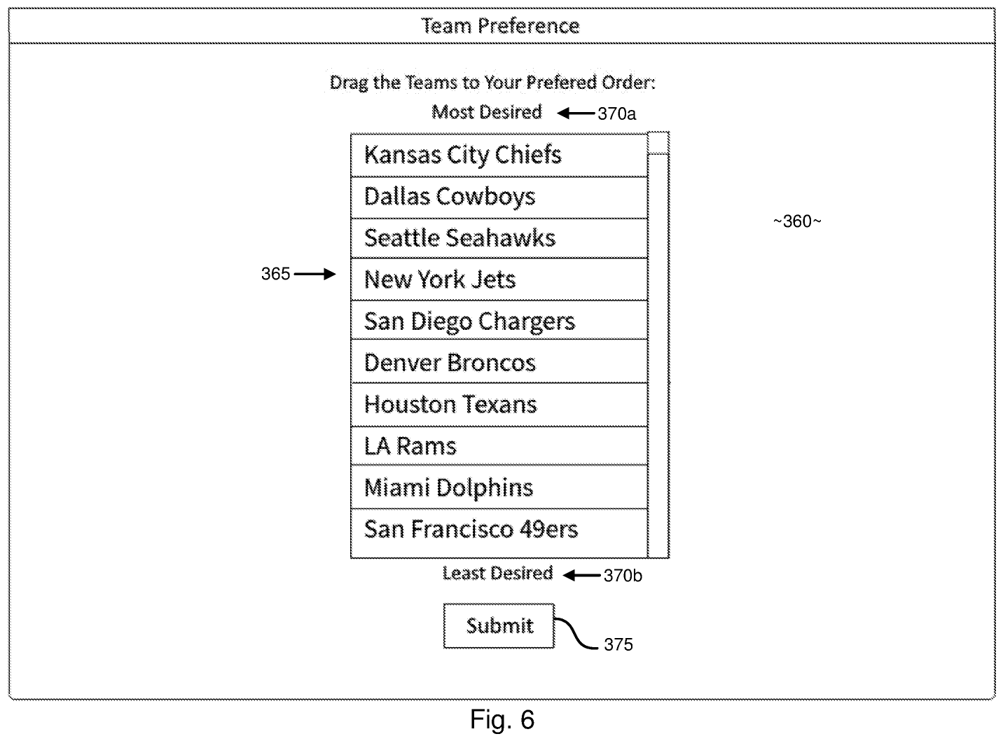

More generally, the matching process is shown in FIG. 1. Before the Match, a given team (Team X, Tx) develops 100 any player selection preferences or algorithms to use when selecting players during the Match. Also prior to the Match, a pool of all available players is registered 105 for the Match in a computerized match system database. The pool of available players comprises current players (Pc) 110 of Tx and non-current players (Pnc) 115 of Tx. Prior to the Match, the players enter their Rank Orders 112 of preferred teams (see FIG. 6).

Tx then makes a selection 120 from the pool of registered players 105, selecting from either the current players (Pc) 110 of Tx from the non-current players (Pnc) 115 of Tx. If Tx selects 125 a particular player (Px) from the set of current players (Pc) 110, that player Px will be matched 130 to Tx without other contingencies. If Tx selects 135 a Pnc that has not previously been selected by another team, the player Pnc is assigned 140 temporarily to Tx. If all higher priority teams, teams with a higher priority selection status, fill their vacancies without selecting Pnc 145, then Pnc is matched 150 to Tx. If Tx selects 155 a Pnc that was previously selected by a lower priority team, the player Pnc is assigned 140 temporarily to Tx. If all higher priority teams, teams with a higher priority selection status, fill their vacancies without selecting Pnc 145, then Pnc is matched 150 to Tx. In all cases, if a higher priority team selects 160 a Pnc, either before or after Tx selects 135, 155 that Pnc, then that Pnc becomes unavailable to Tx 165. For a Pnc (non-current player) of a selecting team, priority as to other teams, i.e. whether the selecting team is a higher or lower priority team than other teams) is determined by the tier level to which the team is willing to assign the Pnc and also how high the team is positioned in the Pnc's Rank Order.

As will described for FIGS. 7-8, team and player graphic user interfaces (GUIs) may use color coding to indicate players that are available, unavailable, assigned, matched or other statuses or indicators. This color coding is also reflected in the diagram of FIG. 1 where, per the Key 170, various colors are indicated by corresponding line patterns. Players still available in the Match process to be selected are indicated by the color green line pattern 171. Players unavailable to a given team to be selected in the Match process are indicated by the color red line pattern 172. Players temporarily assigned to a team are indicated by the color blue line pattern 173. Players matched to a given team are indicated by the color red line pattern 174.

If a lower priority team selects 175 a Pnc that is eventually selected by a higher priority team, that Pnc will be made available to the higher priority team. When a higher priority team selects 180 a Pnc, that Pnc becomes unavailable 165 to that lower priority team. Once all Tx vacancies are filled 185, the remaining unselected players will show an unavailable status 165 to Tx.

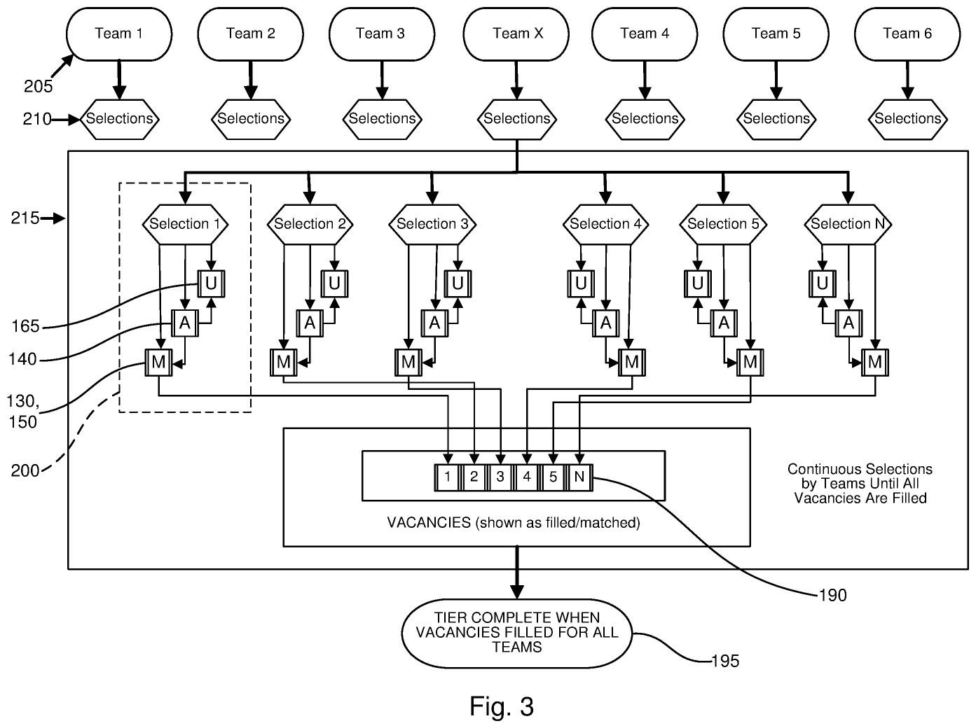

As shown in FIG. 3, Tx and the other teams in a league keep making selections until all vacancies in all teams are filled 190 for a given tier. A tier is complete 195 when vacancies have been filled for all teams within the tier. FIG. 3 illustrates the selection and match process shown in FIG. 1 for a given team Tx as a subset 200 of the same process being replicated until all Tx vacancies are filled. By way of example, Teams 1 through 6 are shown 205 in FIG. 3, as are their individual selection processes 210 in the Match, only the individual selections 215 for Team X (Tx) are shown for brevity and due to space constraints. It should be appreciated that all teams will engage in player selections and matches to fill their roster vacancies. Availability 165, assignment 140 and match 130, 150 player statuses are indicated in the individual Team X selections by the letters “U” for unavailable, “A” for temporarily assigned, and “M” for matched.

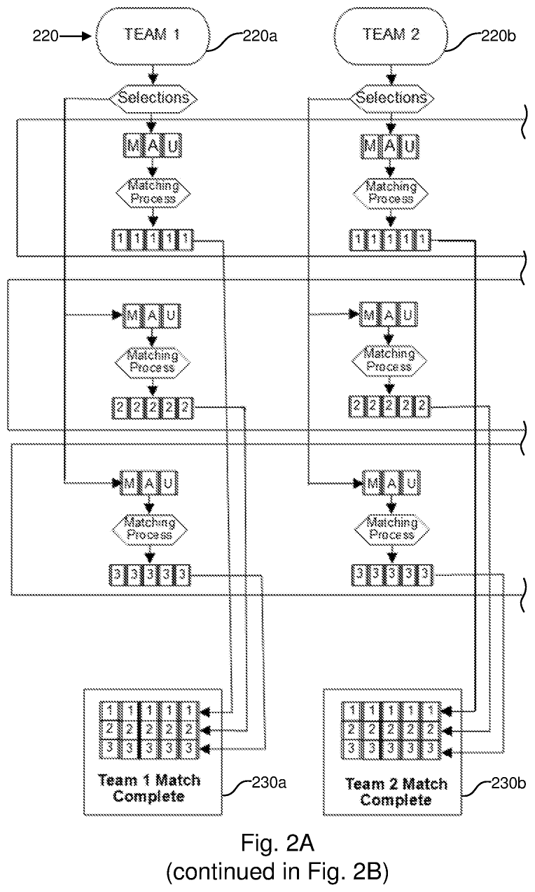

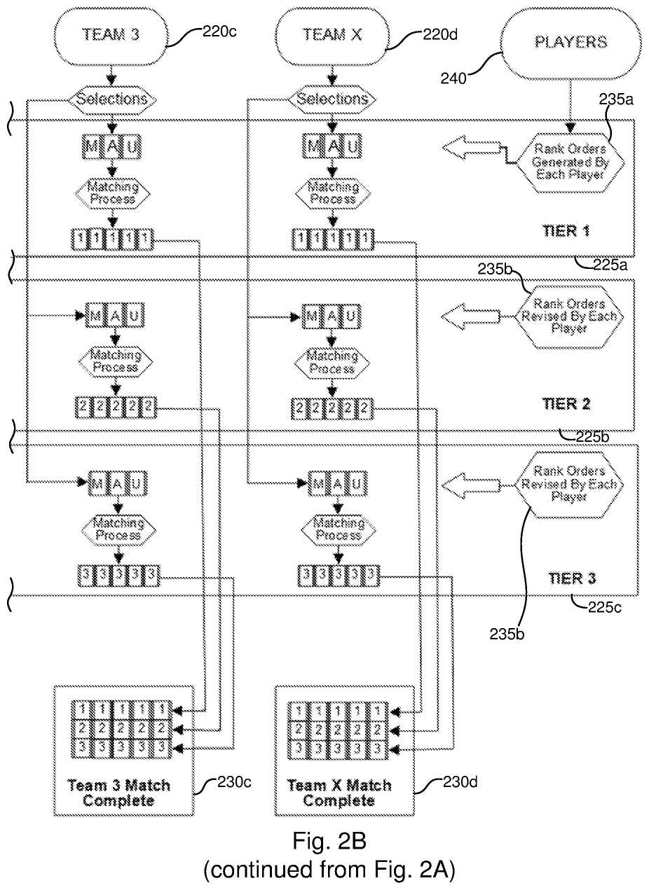

FIG. 2 is a diagram illustrating an overview of the match process in which, by way of example, matches across four teams (Team 1 220a, Team 2 220b, Team 3 220c and Team X 220d) and three tiers (Tier 1 225a, Tier 2 225b, Tier 3 225c) are illustrated as being filled, thereby filling all team vacancies. As shown, each team roster 230a, 230b, 230c, 230d is filled in all three tiers and the Match is complete. Provision of Rank Orders 235a, 235b and 235c by participating players 240, prior to the selection process is also indicated.

Several of the logistical parameters would need specific clarification before actually employed by a league. The submission interval is one of those. Submission intervals can be any from a few minutes to an hour depending on league preferences and practices. If teams select many of their current players, then submission intervals can be long to allow teams to reconsider options throughout the round. In some leagues, teams will have a tendency select the best players from the entire league, i.e., hundreds of selections per team, in hopes that one may unexpectedly Match. For those leagues, submission intervals should be shorter, so the process does not take excessively long.

It also may or may not be necessary to have a Priority Stop. The Priority Stop was created with the idea that teams may literally want to select hundreds of players before settling on their own current players, yet the submission intervals needed to be long enough for teams to reconsider selections during the round. If these two conditions coexisted, the selection process of each round could be very lengthy. The Priority Stop would force the teams to be more realistic about their selections or have them organized to rapidly go through a list of valuable players who were unlikely to match. However, if the process of matching came to a natural close during the Opportunity Interval, then it may be unnecessary to have a Priority Stop.

The Salary Curve and the Superstar Bonus

The Superstar Bonus allows the Tiered Salary System to produce a salary curve which can be made into virtually any shape. The Tiered Salary Structure, without the modification of the Superstar Bonus, would have the systemic flaw of paying players on the same tier the same salary throughout the league. In a league with 8 players per tier, the best and 8th best players per team would be receiving the same salary. This also means the best player in the league and the 256th best player would be making the same salary. Some of this difference would be made up by the number of years on Tier One (or high tiers). Better players will rise to a high(est) tier very early in their careers and stay there for most of their careers. Players who just barely make Tier One are likely to only be there for fewer years. Thus, the difference may salary between the first and 8th best player on the team may not be made up in a single year, but much will be made up over a career. These equity issues are certainly less for players on the lower tiers. Using the same example of 8 players per tier, Tier 4 would consist of the 25th through 32nd best players on the team. The ideal salary curve may very well be quite flat at this point, such that the true differences in value between these players is very slight. Thus, paying those players (25th-32th best) the same salary is reasonable. Over the course of a career, any equity issues between being one of the better or worse players on that tier will likely balance out if the salary curve is relatively flat for that tier.

Nonetheless, it still is an equity issue to pay the best few players in the league the same salaries as the 200-250th best players. It has already been established that it would be difficult to come up with a different base pay, i.e., defined in the pre-season, for the better players. Thus, the difference can be made up on an incentive basis at the end of the year. This, in fact, is a familiar formula in the free agency model as well. Players often have stipulations in their contract which allow them to get incentive pay based on a variety of quality measures. In the Tiered Salary System, a system of post-season incentive bonuses allows the most valuable players to be paid their true value. In fact, the Superstar Bonus allows the salary curve to be made into virtually any shape. The Superstar Bonus is created by taking money out of the ordinary pay scale and repaying that money back to given players. As an example, one can assume an NFL team with 53 players on 6 tiers and a salary cap of $150,000,000. The first 5 tiers have 8 players each and the 6th tier has 13 players. The players are paid using the following ratio from Tiers One through Six: 12, 8, 5, 3, 2, 1.

TABLE 3

| | No Superstar | $20M Superstar | $40M Superstar |
|---|---|---|---|
| Tier | Bonus | Bonus | Bonus |
| 1 | 7,114,624 | 6,166,007 | 5,217,390 |
| 2 | 4,743,083 | 4,110,671 | 3,478,260 |
| 3 | 2,964,426 | 2,569,169 | 2,173,912 |
| 4 | 1,778,656 | 1,541,501 | 1,304,347 |
| 5 | 1,185,770 | 1,027,667 | 869,564 |
| 6 | 592,885 | 513,833 | 434,782 |
| Superstar | | 20,000,000 | 40,000,000 |
| Bonus | | | |
| | 150,000,000 | 150,000,000 | 150,000,000 |

The column labeled “No Superstar Bonus” was calculated with the above ratio assuming all 150 M went toward the regular pay scale. However, if 20 M were set aside evenly, the pay scale would be reduced per the column labeled “20 M Superstar Bonus.” In other words, the salaries were created using 130 M for the regular salary scale. The far right column was calculated assuming a 40 M bonus. It would be possible to set aside the superstar money using a different formula. In these figures, the bonus money is taken proportionately from everyone's salary. It would also be possible to take out money disproportionately. One could set aside money from the whole of Tier One and given back to one or two players. This would shift money so the salaries of players 3-8 (the lower portion of Tier One) to the top two players, which some might consider more appropriate.

There is tremendous latitude in how the money is set aside for the superstar bonus and how it is paid out. If one really feels that the better players in the NFL should be paid 25 M/year, then virtually all of the superstar money can be focused on 1-2 players. It also can be spread out using many formulas. One can give money to a team MVP for offense, defense, and special teams. The amount paid out to these three does not have to be the same. It can be handed out based on team MVP's and league all-pro selections, with many players getting money based on both selections. If starting quarterbacks are felt to deserve more, then it would be possible to set aside money with the quarterback who took the most snaps for each team getting the bonus. Giving a Superstar Bonus based on pure statistical measures (most yards gained, most touchdown passes) is discouraged since one would not want to alter a player's game to hit statistical targets resulting in bonuses.

Regardless of how the Superstar Bonus is configured, there are several features which are consistent:
The Superstar Bonus configuration does not change the selection/distribution process which determines which players match to which teams
The Superstar Bonus does not change the overall Salary Cap figure. The Salary Cap figure is determined the same way it is currently determined in leagues with a salary cap: via collective negotiation between the league and the players. A Superstar Bonus would be essential if one wanted to recreate the same salary curve that is currently a reality in the National Football League. There is a very steep slope of the current (free agency) salary curve within the range that would be Tier One. A Superstar Bonus would be needed to drop the effective salary of the bottom part of Tier One and raise the salaries dramatically for the star players. One should be reminded, however, that part of the Tiered Salary System is that star players earn relatively high salaries earlier in their careers than in the free agency system. In free agency, the exorbitant salaries help remedy the low salaries that excellent players earn while they are under free agent restrictions. Looking at the example of Russell Wilson presented earlier, he likely would have been a Tier One player starting his second season as a Seattle Seahawk. His peak earnings in the Tiered Salary System ($7 M/year) seems extremely low compared to the 22 M that he makes in free agency. The earnings over the lifetime of his career are not as different as may seem. Because of free agency restrictions, he earned only 3 M his first 4 years in the league. In the Tiered Salary System, he would have gotten a Tier One contract starting year 2, making his earnings about 22 M over the first 4 years in the league. His total earnings over 8 years in free agency will be about 90 million. If the Tiered Salary System had been in effect when he joined the league and one assumes no Superstar Bonus, he would make about 50 M during his first 8 years. This would be about 0.5 M his first year and then a little more than 49 M over the next 7 years. With a Superstar Bonus, he would make less in regular pay (probably about 40-45 M) for the 8 years, but he could very well have made 20 or more over the 8 years in Superstar Bonuses. Thus, in the Tiered Salary System, Wilson would probably have made roughly 55-60 M over 8 years, depending on the formula used for the superstar bonus. It is likely that the Tiered Salary System will result in a somewhat flatter salary curve, making the salaries lower for the very high end of the pay scale.

The Superstar Bonus may be employed in certain embodiments of the invention.

Trades, Practice Squads, and Injury Replacements

The details of trades, practice squads, and injury replacements can change significantly without altering the fundamental benefit of the Tiered Salary System. There is certainly a good deal of latitude which can be employed for these issues. However, a good starting point will be described.

Trades

The Tiered Salary System is admittedly not trade-friendly during the season. During the offseason, trades are relatively easy. Teams can trade whatever combination of players they choose. “Current team” status is actually what is traded. 4 players can be traded for 1 player. Tier One/Two players can be traded for Tier Three/Four. Any combination of players which the teams want to trade can occur. A trade, of course, does not guarantee the team receiving the player will match the player, unless they select that player during Tier One. There are players, however, which may be clearly excellent Tier Two or Tier Three players who are very unlikely to justify higher tiers. Thus, it may be a very reasonable bargain for a team to trade for that Tier Two or Tier Three player given the high likelihood of a Match at that tier. There is also nothing illogical about trading a Tier One for a Tier Two player. A team may have priority on a Tier One player whom it doesn't plan on selecting during Tier One the following year. That team may also feel that another team will select that player during Tier One, which means that player will be lost to the team. The team may improve itself at Tier Two by trading their Tier One player for a Tier Two player who represents an improvement on their Tier Two players.

Trades during the year; i.e., after the Match, are more problematic. In theory, there should be no problem about trading players at the same tier. A Tier Two player can be traded for another Tier Two player. The salary burden remains unchanged. However, trading in between tiers becomes more difficult. A potential resolution to this may be possible, but the Tiered Salary System does not, as the time of this writing, allow post-Match trading of players at different Tier levels.

There is also the possibility that veteran players can veto trades, as some veteran players can do currently. That is a decision which can be adopted by a league if decided by collective bargaining. The merit of the Tiered Salary System does not greatly depend on whether trades are or are not subject to vetoes by veteran players.

Another issue arises with veterans who wish to be traded. In the free agency system, a player can negotiate with anyone at the conclusion of his contract. Theoretically, that means he can join any team he chooses. Practically, his options are limited to teams who have needs for a player of his skills at his relevant salary range. In the Tiered Salary System, an excellent player who is elevated to Tier One status during his second year may never have the option to ever join another team since his services will always want to be retained by the team which drafted him An East Coast person may be “stuck” in Oakland permanently, or a Florida native may be forever in Detroit or Minneapolis. There are no options, as the system has been described to this point, for such a star player to move to a more desirable team.

There are potential solutions to create options for the veteran if it is desired by mutual consensus between the league and the players. Some options are:

1. Negotiate parameters into the Collective Bargaining Agreement by which veteran players can force a trade with compensation to his original team decided by mandatory arbitration. For example, between years 5-9 in the league, and then for years 10+, a player who has been Tier One for at least 3 consecutive years, may request arbitration to be traded to one of six teams. His current team would be forced to accept reasonable compensation (in terms of player trades or draft picks) for that player.

2. A veteran player can have the option of excluding teams from his Rank Order for which he does not want to play. Thus, if a player only wants to play in California, he can only list California teams in his Rank Order. If he is not selected by any California teams in the Match, he simply goes unmatched. Compensation could, or could not, be determined after the fact by binding arbitration. If no compensation is required, it would be recognized that the team who lost the player would suffer a true loss. Thus, compensation is the preferred approach.

3. If a Comprehensive Match strategy is utilized, then it would be possible to create parameters whereby a veteran player can identify a lower tier selection by a more preferred team to have a higher priority than a higher tier selection by a less preferred team. Thus, a second tier selection by the Los Angeles Dodgers may have a higher effective priority than a first tier selection by the Detroit Tigers. It should be emphasized that this is not the preferred embodiment of the invention; if this mechanism is utilized at all it should be utilized sparingly.

4. None of these possibilities which force trades or give lower tier teams higher priority are considered beneficial, but they should be considered options if there are parties which feel these alterations are necessary in order to maintain fair and reasonable options for the players.

Practice Squads

Practice squads can serve a crucial role in the Tiered Salary System. Practice Squads are, in effect, the reserves for each team. Injuries, unexpected poor play, and suspensions for violation of team/league rules are all part of the realities of professional sports. Any of those circumstances can lead to vacancies within the season which need to be filled. Practice squads allow promotion to fill these vacancies.

The creation of practice squads can be formed as an additional Tier. After the “last” tier of regulars has been selected, an additional tier for the practice squad can be undertaken. The size of the practice squad should be sufficient that it would be unlikely a team would have to draw on players outside the practice squad to fill vacancies.

The more difficult question is what happens to the salary of a player when he is demoted from the team in favor of someone from the practice squad. This can have different solutions whether the reason for the demotion is injury, rules violations, or poor play. There is a disincentive to distinguish between those causes since it would promote false reporting by the team. The most sensible approach is to not change the salary at all except for a rules violation. Players promoted from the practice squad will still receive practice squad pay, but they will get a chance to show their play in game situations, increasing their chances for matching to the regular team for the following year. Players demoted will still be paid for that year but face declining likelihood of maintaining their salaries for the following year. This certainly is amenable to some formula changes depending on the preferences of the league and the players' union.

An alternative would be for salaries to be structured as “base pay” and “per game” pay. Base pay would be determined by the tier at the start of the season. For example, imagine if the bottom regular tier had a pay of 500,000/year and the practice squad players had salaries of 100,000/year. The bottom tier could be divided between 180,000 base pay (which they would receive regardless) and 320,000 (20 K/game×16 games) of “per game” pay. A player is due the 180,000 base pay regardless of what happens during the season. However, if a player is demoted due to poor play or rules violations, he loses the 20,000 per game multiplied times the number of games left at the time of the demotion. The practice squad player who is promoted then picks up the 20,000/game for the remainder of the season.

It is also a league-specific issue about whether players can freely be promoted or demoted within the team during the season due to one of the reasons stated above. As a guiding philosophy, the Tiered Salary System allows for re-evaluation for players annually with their pay and status readjusted appropriately every year. It is problematic if adjustments/promotions/demotions take place in the middle of the year. This still represents a much more accurate system for player re-evaluation than the free agency system, where teams make commitments many years into the future based on anticipated performance. The freedom to promote/demote to and from the practice squad will be guided by the preferences and demands of that particular league at issue.

Injury Replacements

Injury replacements will come primarily from practice squad. If a suitable replacement is not available on the practice squad, several options exist. One option is to trade practice squad players (effectively, these players are on the same tier) with another team to find a suitable player. Another option is to demote a player off of the practice squad and promote a player not currently in the league onto the practice squad who is capable of being the injury replacement. Then the injury replacement can take place as usual. This represents an equity issue as the player demoted did nothing wrong to deserve being demoted, other than playing a position which did not require injury replacements. However, this may be the fate of players at the bottom of the practice squad: that they are at risk for being cut during the season. Another option is to allow a team to add a practice squad position to the team (not a large financial advantage). That player added can then immediately be used as the injury replacement. However, if that option is used the injured player should have a mandatory number of games in which he cannot play in order to justify the creation of a new practice squad position.

The Tiered Salary System: Why it is Better

It Makes a Better Game

It cannot be overemphasized that there is nothing more important than providing a high-quality product for the public. Professional sports has become more lucrative and profitable as time has advanced, but this will not last. It is vital that professional sports do everything possible to deliver the best game on the field, the best relationship with fans, and the best public image possible. The competition with other entertainment industries is vital. It would be foolish for sports to assume that the fans will always to continue to pay ever increasing amounts to witness and be a part of the game regardless of the product and presentation of the sport. The debacle of national anthem protests is only a small taste of the fragile position of professional sports in the United States.

The Tiered Salary System will make a better game in several ways. Currently, valued free agents suddenly depart teams, disrupting team chemistry and leaving huge athletic voids. In the Tiered Salary System, there will be no sudden departure of the most players on a team, unless it is in the strategic interest of the team. Teams can always depend on keeping their Tier One players if they choose. There will be some Tier Two players lost (necessary for parity) to lesser-skilled teams who wish to promote them to Tier One when their current team cannot do so. However, the shifting will be driven by real-time decisions regarding the performance of the players. These decisions regarding player movement will not be trying to predict performance years in advance.

Players will know that their performance must be kept at peak levels in order to retain their income status; this motivation will keep performance level maximized. This is an issue not much discussed in professional sports, likely since long-term contracts are currently seen as unavoidable, and there is a certain futility in discussing the impact of an unavoidable situation. The Tiered Salary System makes long-term contracts obsolete. The reality is that professional athletes are subject to the same internal forces as any other person. Some people (probable very few) are internally driven to the point where external consequences (positive or negative) have little impact. Most of us, however, are shaped by positive and negative reinforcements, such as increasing or decreasing salary levels. Others are affected by injuries or simply bodily stress issues which are common in players. Others will have lifestyle changes. Players near the prime of their careers are at the age where many will begin to have families, and the understandable desire for family life may draw them away from the training required from peak performance. Many players have contracts that will end during the prime of their careers, and these players may be acutely aware that their performance will dramatically affect their payoff at the contract's endpoint. Others, however, have contracts that will end near the end of their prime years, and their “big-time” earning will be over. Their performance during the span of that contract will thus not substantially affect their lifetime earnings. Others will feel OK to “slack off” for the first year or two of a 3-4 year contract, feeling that their performance the last 1-2 years will dictate their upcoming contract.

Others will receive such a lucrative contract (far beyond their wildest dreams) that they simply have no more drive to make any more money; these players feel “set for life.” It would be truly difficult for them to motivate themselves with this financial security.

These realities are well accepted in any other venue. We readily accept that workers who are difficult to fire (stereotypically many government employees) will work to the level that will retain their jobs and no more. Similarly, we acknowledge that grades are necessary for students in school to motivate them to a higher performance. A simple “pass/fail” grading system may be liked by the students, as it takes the pressure off. The players' desire for long-term contracts is understandable, and that desire is not itself criticized. We all want financial security, and most rational people would negotiate towards that end if it were possible. The question is not whether the players are acting appropriate (they are); the question is whether it is better for the sport. In the same way that students may grudgingly admit that letter grades may motivate them towards higher effort/achievement, players should admit that annual re-evaluation should motivate them towards maintaining peak performance. This peak performance will optimize the performance of the game.

The lack of disruption of team chemistry will also make a better game. Simply switching players around as contracts end is a detriment to the game. A team is a functional unit and not a mere collection of individuals (though the impact of team chemistry varies from sport to sport). Controlled player movement can be valuable for optimizing team performance, as the needs of any team change from year to year. Parity would also dictate that players have some movement so that the number of better performing players on each team can continually readjust itself. There is movement of players from team to team in both the free agency and tiered systems, but the tiered system is more logical. If a team has collected more than its share of valued players, it must lose some of them, but can assert its will to keep a certain number of them. A team with fewer good players will have some opportunity to obtain some better quality players. The movements will be logical and based on real-time performance

Improved Equity

The Tiered Salary System distributes the limited salary dollars among the players more fairly. It does so in two ways. First of all, the salary curve will be more fairly drawn. Currently, the shape of the salary curve is the sum of individual and separate negotiations between each player and his respective team. It would be erroneous, however, to think that every player gets his chance to petition his value to his team. The most valued players are the ones who sign longest-term contracts. These relatively few highly paid players consume a phenomenally disproportionate fraction of the limited (salary cap) funds.

After these contracts are in place there is relatively little money left for everyone else. Given the number and type of players that are required for each team, the limited remaining funds for the majority of players gives little latitude for salary negotiations. In 2016, 40% of the money was paid to the top 10%, and 60% to the top 20% of players. Thus, the monetary margin for the remaining 80% is very slight. In other words, the salary curve is preordained after those top 10-20% of players have been signed. There is no oversight or plan as to the amount given to these top 10-20%, and whether it leaves a reasonable amount for the remaining players. In lieu of this process, the shape of the salary curve should be decided first. The relative value of all players, from the most valuable to the less lease can be predetermined by consensus. Once the shape of the salary curve is decided, then the players are allocated to these various points on the salary curve.

The other improvement in equity is the higher accuracy of the pay-for performance. Pay-for performance cannot be accurately predicted into the future, the Tiered Salary System keeps this in real time. The multi-year contracts inherent in the free agency system creates a systemic inaccuracy in correlating salary and pay. A large portion of the salary money available is committed years into the future. Rank-and-file players who pick up their performance have to wait several years before funds become available for bigger contracts. For example, prior to the 2017 NFL season, 75% of the money for 2019 was committed to 50% of the players, leaving only 25% of the money for 50% of the players. With so little money available, there is little margin to compensate our improving players. The pay raise he should have received in 2018 would have to wait until 2020 when the long-term contracts start running out. Unfortunately, he played nearly 3 years underpaid and may never make up the earnings he should have received. On the other hand, a player who receives a big contract in 2017 but underperforms may never regain the promise he had and may never contribute enough to justify all of the money he was paid. The Tiered Salary System minimizes these issues by re-evaluated the players in real time. By optimizing pay-for-performance, the players are paid more fairly.

The principle advantages of the Tiered Salary System are to create: 1) a better game through more ordered distribution of players and better athletic performance; 2) greater equity through better salary allocation and more accurate pay-for-performance; 3) keeping better and more consistent relationships between star players and fans. There are other noteworthy advantages of the Tiered Salary System. Business decisions required by players are minimized. The players' job is simplified: be the best athlete possible. When their athletic abilities are optimized, they will receive the best contract and highest salary the system will allow for someone with their skills. There is no need to figure out whether to ask for more money, less money, or more guarantees. Success is not guaranteed on the best agent or the best selection of advisors. Athletic contracts will become more of a “turn-key” endeavor, where standardized pay scales and contracts are utilized. The nuances of contract/business decisions for multimillion-dollar sports agreements would be challenging for anyone, even if he/she had an extensive background in business and finance. It would not be an overstatement to say that many of the players are not prepared to have proper independent decision-making abilities when it comes to these issues. Relying on an agent to make the correct decision for a player makes no more sense than a financial advisor making a decision for clients who don't understand finance or a real estate broker making decisions for a client who doesn't understand the real estate market. In any of those examples, the client is in a compromised position if he/she doesn't have a good, independent understanding of that market. The standardized nature of the Tiered Salary System is much safer and puts the player in a position where financial regrets are less likely to occur.

Agent Fees Eliminated

Agents will no longer be necessary with the adoption of the Tiered Salary System. Agents serve two principle purposes: 1) make contact between their clients and prospective teams so negotiations can be undertaken, and 2) help negotiate contracts. Neither of those functions will be required with the Tiered Salary System. Player registration will be straightforward for the vast majority of players. The players will be assigned to a team per the algorithm previously described. The contract, including the salary, will be standardized. Agents charge roughly 2-3% of players' salaries, perhaps a bit more in some cases. If one assumes agent fees of 2.5%, a salary cap of 153 M, 32 teams, and 53 players/team, the NFL players pay a total of 122 M/year in agent fees. This represents a significant saving. Logically, the saving should be enough to have owners, league executives, and union executives be motivated to evaluate the merits of the system.

In a further embodiment of the present invention, a salary allocation system for professional sports, salaries in a sports league are pre-set and arranged hierarchically into tiers. All players in the league are selected and assigned to a tier on a frequent basis, typically on an annual basis. The selection and assignment process is implemented on a computerized match system and may be referred to herein as the “Match.”

In order to implement the Match, teams and players undergo off season decision-making Tier structures are created via league consensus arrived at through collective negotiation between league officials, team officials and players' representatives. Creation of tier structures includes determining a designated number of tiers and a designated number of player positions (roster positions or team vacancies) per tier. In a typical tier structure, there are four to five tiers, with Tier One being the highest paid tier and tier four or five being the lowest paid tier. League consensus determines compensation per tier. Players in each tier may be characterized as follows:

Tier One: Star players and above-average starters

Tier Two: Most of the remainder starters

Tier Three: Occasional starters and important bench players

Tier Four: Regularly used role players

Tier Five: Reserves

Match Selection Algorithm

All selections of players to roster positions are determined according to the Match selection algorithm. If a player is selected by more than one team, the player is assigned (matched) to the team with the highest priority among those teams that selected that player. During the selection process, a team cannot rescind a player selection (offer) once made. A player also cannot refuse a selection (offer/contract) if assigned to fill a selecting team roster position by the system via the Match selection algorithm.

The order of priority is as follows:

1. The highest level tier in terms of designated player salary for that tier.

2. The player's current team.

3. The team that is higher on the player's Rank Order. Note that in some embodiments, and/or for certain classes of players, the order of priority may be altered.

In a Match that is performed sequentially by order of tier hierarchy (tier-by-tier), selection/matching in higher tiers (i.e. higher paid tiers) is performed prior to selection/matching in lower tiers (i.e. lower paid tiers). Thus, players that have been selected in higher tiers (e.g. offered higher tier contracts) are no longer available for lower tiers. If more than one team selects a player at a given tier, the current team will have a higher priority than any other team, followed by the teams as ranked in priority in the player's Rank Order.

According to this embodiment of a Match Algorithm, the highest possible priority exists when a player's current team select that player as one of their highest tier (Tier One) selections. As a result, superstar players will rarely move teams, which will create more stability for the league. This is the highest possible priority selection regardless of the tier level of the player the prior year. A Tier One selection/contract offered by the player's current team has the same priority whether the player was a Tier One or a Tier Five player the prior year. Via this system, a team can always depend on keeping any player as long as it is willing to offer that player a Tier One contract.

Preparation for the Match

League Preparation: A league identifies player to participate in the Match. These players will be offered to register for the Match through a computerized system interface. Players will typically be identified as:

1. Those who recently played for the league;

2. Players drafted by teams in an amateur draft;

3. Any other player desired by any team based on workout performance or other recommendations.

In further preparation, the time and location of the Match is determined. The Match event may take place at a physical location where team and league representatives congregate, or it may conducted virtually/solely online. Whether conducted at a physical or virtual location, the Match is conducted using a computerized matching system including computerized system interfaces.

Player Preparation: Each player creates a Rank Order list, which is a hierarchical list of all teams in the league, ranked in the player's order of preference.

Team Preparation: Each team makes internal decisions regarding preferred player choices in anticipation of the Match.

Matches with Simultaneous Selections: Tiered Salary Structures in School Districts

In certain embodiments of the present invention, the matching system and process includes a dependent group and an independent group. The dependent group submits preferences to a computerized matching system database via a computerized system interface in communication with the computerized matching system. The independent group makes selections during the match also via a computerized system interface in communication with the computerized matching system. The computerized system interfaces, available to each participating school, show a visual representation of all applicants for teaching positions including a code associated with each application to indicate status among various categories, such as:

1. Available for selection (green)

2. Unavailable for selection (red)

3. Selected but not matched (blue)

4. Matched (gold)

In some embodiments, status is indicated by color on the applicant visual representation on each computerized system interface. Initially, all applicants are indicated/identified as being available to select and potentially match. Each participating school is allocated a certain number of positions for an admitting class, referred to as class vacancies.

In this example, each school has a number of factors to consider when hiring a set of teachers, including such factors as:

1. Subjected taught by a candidate teacher

2. Seniority

3. Salary requirement

4. Diversity goals of the institution

5. Expertise or availability to lead extracurricular activities (e.g. coaching or science, robotics, or language clubs)

Instead of schools competing with each other, trying to hire teachers away from other schools, a matching market can be utilized. On a scheduled basis (e.g. every 2 years) the teachers in the school district can be re-assigned via a matching market. Teachers can submit a rank list ahead of time. Schools can make selections during the matching process to formulate a faculty which balance the above characteristics. The match may be separated based on:

1. Subjects taught

2. Extracurricular activities

3. Salary

There may be a priority where each school has a certain number of higher salaried positions which have a higher priority to allow each school to obtain necessary faculty. If more than one school wishes to select an applicant, the applicant will be assigned to the school that is higher on that applicant's preference list, regardless of whether the less preferred school already selected the applicant—the selection by the higher preferred or ranked school will prevail and obtained the assignment and match.

At a specified time, the Match begins, with each participating school making selections among the applicants to fill their vacancies. These selections (which may or may not result in an assignment) typically occur concurrently and ongoing during the Match process. In certain embodiments, there is a submission interval, which is a maximum amount of time allowed in between selections.

If a school (School A) selects an applicant, all of the schools who have a lower priority (lower on the applicant's rank list) have no possibility of matching that student. Thus, from that point forward that applicant will be viewed as unavailable (red) for all schools who have a lower priority for the applicant than School A. The applicant will remain indicated as available (e.g., coded green) for schools who have a higher priority than School A for that applicant. The applicant will appear as “assigned but not matched” (e.g., coded blue) for School A. If a school with higher priority than School A then selects the applicant, the applicant will disappear from the vacancy position of School A and appear on the vacancy position of the higher priority school. If no other school selects the applicant, the higher priority schools will eventually fill their vacancy positions.

When all of the higher priority schools have no more vacancies and can make no more selections, the applicant turns from “blue” to “gold” for School A. In other words, when higher priority schools fail to select that applicant, the applicant will eventually match to School A, or whoever school has most recently selected the applicant. This process continues until there are no more vacancy positions for any of the schools.

In certain embodiments of the present invention, a simultaneous selection match may progress as follows:

1. Members of a dependent group register for a match and submit hierarchical preferences to a computerized matching system database via a dependent group computerized system interfaces. Members of an independent group register for a match via independent group computerized system interfaces. Registration may follow or precede any investigative efforts of either the dependent group or independent group members, such as interviews.

The computerized matching system displays all dependent group members, including each dependent group member availability status, typically coded by color, upon the independent group computerized system interfaces, such as upon the screens of computers (PCs) or mobile devices. Independent group members then make selections among the dependent group members. Once selections are made, they typically cannot be rescinded. Members of the dependent group cannot refuse a selection.

A selected dependent group member is assigned to a selecting independent group member that ranks highest on the selected dependent group member's hierarchical preference list. A dependent group member typically has the option of leaving one or more certain independent members off of the dependent member's preference list, if the dependent member would rather not be matched at all in the process rather than be matched with an undesired independent member.

The selection by independent group members continues until all vacancies are filled at which time the status of all selected dependent members filling such vacancies will be indicated as matched (e.g., coded gold).

Computer Implementation of a Tiered Salary System

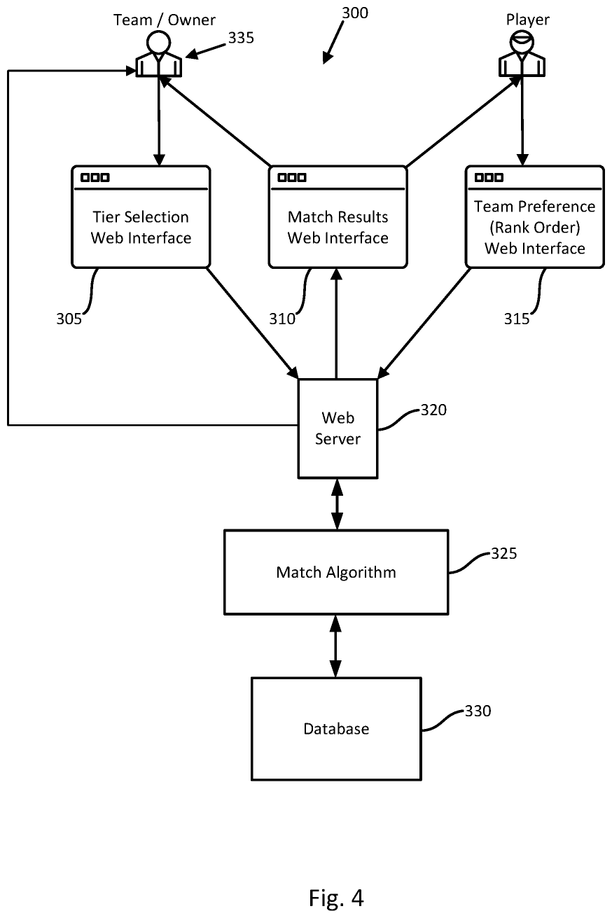

As performance of the several processes of the present invention requires computer implementation, FIG. 4 illustrates an embodiment of the invention on a computer system 300 including one or more web interfaces 305, 310, 315, a central server 320 (which typically functions as or in conjunction with a web server) accessible via such web interfaces 305, 310, 315 over the Internet or, in certain embodiments, over an intranet. The match algorithm 325 and other processes of the present invention may be run via computer code on the central server 320 or may be distributed to remote or other computer processors. Similarly, data provided or generated by the system and provided or generated via user input may be stored in one or more databases 330 which are stored on the central server 320, a separate database server, or distributed to remote or other computer processors.

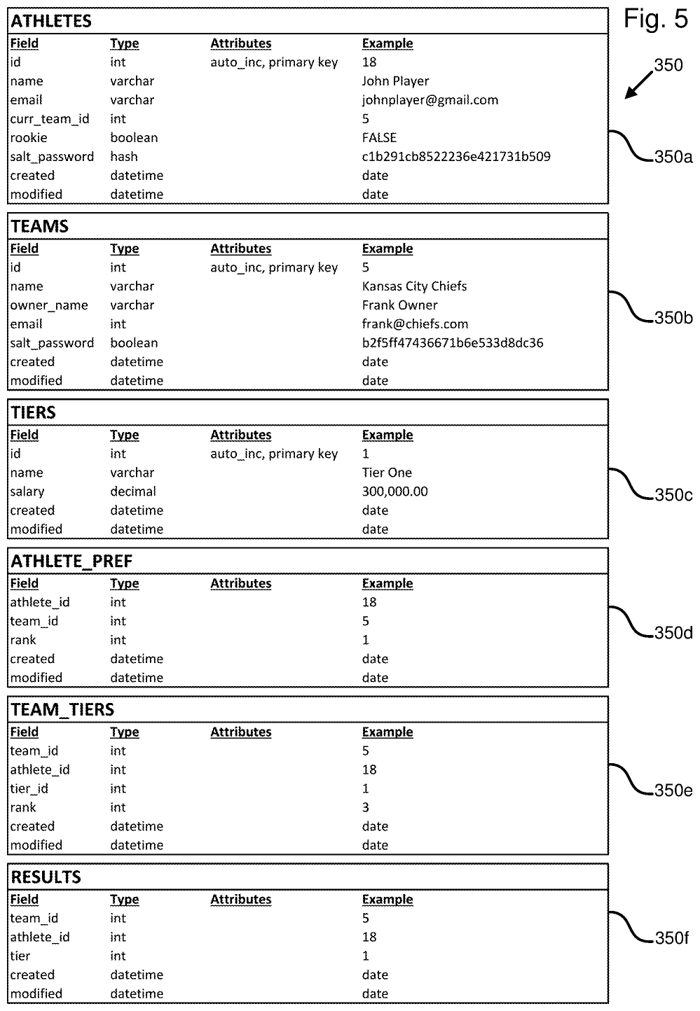

In certain embodiments, the database 330 may comprise tables 350a-f that store relevant information regarding athletes (players), team, tiers, athlete preferences, team tiers, and results (see FIG. 5). Athlete data tables 350a may include data such as a unique player identification (ID), player name, player email, any current team ID, rookie status, and player password for accessing the Match system. Team data tables 350b may include data such as a unique team ID, team name, owner name, owner email, and owner password for accessing the Match system. Tier data tables 350c may include data for each tier such as tier ID or level, tier name, and the player salary designated for the tier. Player preference or Rank Order data tables 350d may include data such as player ID, team ID, and team rank. Team tier data tables 350e may include data such as team and player (athlete) IDs, tier level, and team rank in the player's Rank Order. Match results data tables 350f may include data such as team and player (athlete) IDs, tier level to which the player has been matched for that team. The data tables 350a-f may also include the date each record was created and modified. Note that all information shown in FIG. 5 is merely exemplary.

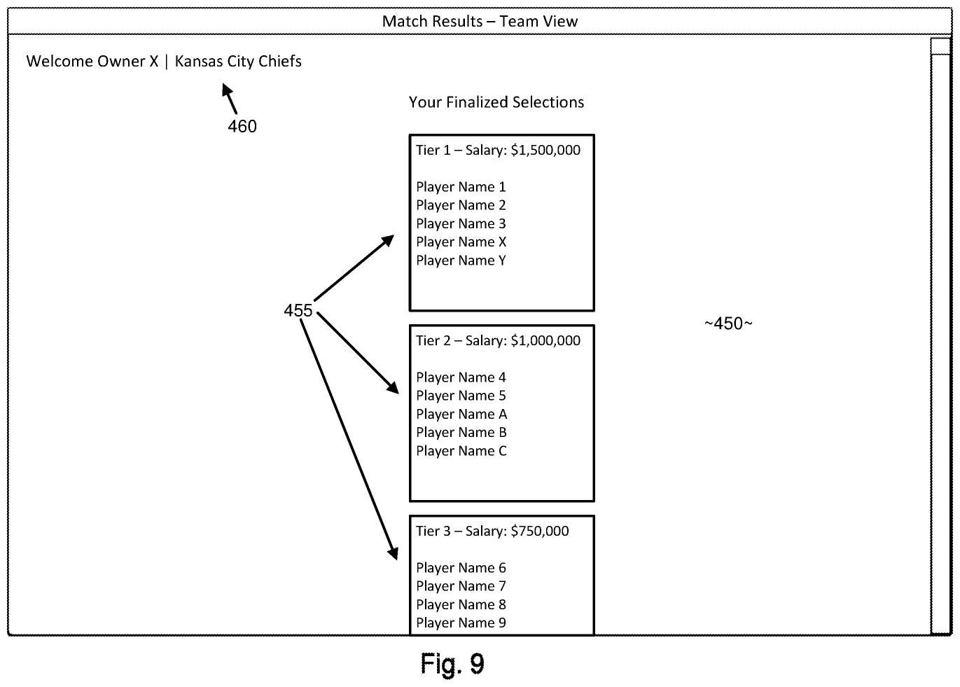

In use, a team owner 335, or representative or agent thereof, makes selections for their respective teams via a web interface 305 or front end comprising a graphic user interface (GUI) displayed via a browser window or custom web application (see FIGS. 7 and 8). First, the team owner logs into the system via the GUI using one or more certifications unique to that owner and assigned to that owner within the system. Such certifications may include a username and password but may also include biometric or electronic certifications, such as fingerprint reader, magnetic card reader, RFID reader, chip reader, or the like, as known in the prior art for certifying a user to a computer or computer system. After certification, the owner may then continue to interact with the system GUI to enter information requisite for the system to generate a Match and to view results of the Match (see FIG. 9).

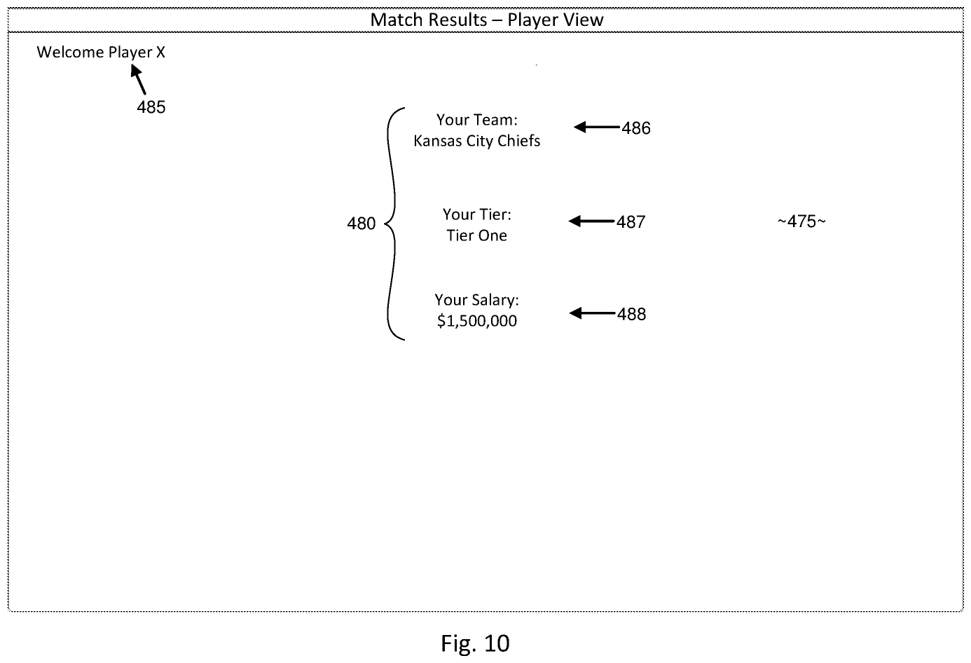

A player may also interact with the system via the same GUI web interface or application, or a different front end platform, i.e. either a player-specific starting interface 315, or an initial interface also used by the team owner that takes the player to a different, player-specific, interactive web or application page once the player enters their credentials. The player may interact with the system GUI (see FIG. 6) to make selections of their preferred teams and may then further interact with the GUI to view results of the Match (see FIG. 10) via the same GUI or a specific web interface 310 for displaying match results. The match result interface may be the same or different for players and teams.

FIG. 6 illustrates an exemplary player GUI or web interface 360 for creating a Rank Order of the player's team preferences. As illustrated, a player may drag and drop team names 365 to sort player team preferences from most desired 370a to least desired 370b. Once all league teams have been thus sorted, the player may further interact with the GUI to submit 375 the Rank Order to the computerized match system.

FIG. 9 illustrates an exemplary match result interface/GUI 450 for displaying match results 455 to a team (team owner or owner agent). As shown, the GUI indicates the team identity 460, and provides a display of finalized/matched player selections for each tier along with the salary level for each tier or any other desired data the league or system manager decides to present. The data may be drawn from the Results 350f or other data tables 350a-f.

FIG. 10 illustrates an exemplary match result interface/GUI 475 for displaying match results 480 to a player. As shown, the GUI 475 indicates the player identity 485 and provides a display of the identity of the team 486 matched to the player, the tier level 487 to which the player was selected and the corresponding player salary 488, along with any other data the league or system manager decides to present. The data may be drawn from the Results 350f or other data tables 350a-f.

It is to be understood that while certain forms of this invention have been illustrated and described, it is not limited thereto except as far as such limitations are included in the following claims and allowable equivalents thereof.

Having thus described the invention, what is claimed as new and desired to be secured by Letters Patent is:

1. A method of implementing a computerized matching system for assignment of players to teams within a professional sports league, said method comprising the steps of:
a. providing league comprising a plurality of teams and a plurality of players;
b. providing a hierarchical tiered salary structure, with predetermined salaries for each tier and predetermined numbers of players at each tier;
c. a player submitting to a computerized match system, via a player computerized system interface,
a rank order of teams in a league
in order of said player's preference;
d. a team submitting an initial selection of players for a first tier to said computerized match system via said team computerized system interface;
e. said computerized match system prioritizing a match between a selected player and a selecting team based upon criteria comprising:
whether said selected player is a member of said selecting team, and
the rank position of said team within said selected player's rank order;
f. said computerized match system moving a player from a first matched team to a subsequently selecting higher ranked team upon said higher ranked team's selection of said player;
g. said first matched team submitting an alternate player via said team computerized system interface to fill the team position vacancy created by said player movement to a higher ranked team; and
h. repeating steps c through g for each team in said league until all first tier team positions are filled.

2. The method of claim 1 further comprising the steps of:
said computerized match system providing a first time interval for performing steps c through f;
said computerized match system providing a subsequent second time interval comprising a priority stop interval;
selection by a team, via said team computerized system interface, of any desired current players of said team during said priority stop interval to fill any of said team's vacant team positions; and
said computerized match system removing team priority selection status as to any unselected team players.

3. The method of claim 1, further comprising the steps of:
a team submitting, via said team computerized system interface, an initial selection of players for a subsequent tier; and
repeating steps e through g until all such subsequent tier team positions are filled.

4. The method of claim 1, wherein players may reorder their rank order of teams in between each tier selection via said player computerized system interface.

5. The method of claim 1, wherein said computerized match system comprises a central server accessible over the Internet, or over an intranet, by player and team computerized system interfaces, said computerized system interfaces comprising web interfaces.

6. The method of claim 1, wherein a portion of the total funds available for allocation by a team to fund player salaries at each tier is set aside to fund a superstar bonus for payment to highest valued tier one players in addition to tier one salaries.

7. A method of performing a comprehensive match of players to teams in a sports league in order to generate a tiered salary structure, said method comprising the steps of:
a. providing a league comprising a plurality of teams and a plurality of players;
b. providing a computerized comprehensive match system;
c. each participating player submitting to said computerized comprehensive match system, via a player computerized system interface,
a rank order of teams in a league in order of said player's preference;
d. said computerized comprehensive match system providing, via said team computerized system interface,
a display of all players by name or other indicia,
a display of system tiers, via numerical or other indicia, proximate each of said player names,
a display of tier selection status, via color or other indicia, for each of said system tiers for each of said players,
e. each participating team submitting a selection of players to said computerized comprehensive match system via said team computerized system interface;
f. said computerized comprehensive match system prioritizing a match between a selected player and a selecting team based upon criteria comprising:
tier level;
whether said selected player is a member of said selecting team;
the rank position of said team within said selected player's rank order;
g. said computerized comprehensive match system moving a player from a first matched team to a subsequently selecting higher ranked team upon said higher ranked team's selection of said player;
h. said first matched team submitting an alternate player to fill the team position vacancy created by said player movement to a higher ranked team; and
i. repeating steps e through h for each participating team until all team positions are filled.

8. The method of claim 7, wherein a portion of the total funds available for allocation by a team to fund player salaries at each tier is set aside to fund a superstar bonus for payment to highest valued tier one players in addition to tier one salaries.

9. A method of performing a simultaneous selection match, said method comprising the steps of:
members of a dependent group register for a match and submit hierarchical preferences to a computerized matching system database via a dependent group computerized system interfaces;
members of an independent group register for a match via independent group computerized system interfaces;
the computerized matching system displays all dependent group members, including each dependent group member availability status, upon the independent group computerized system interfaces;
independent group members make selections among the dependent group members; and
a selected dependent group member is assigned to a selecting independent group member that ranks highest on the selected dependent group member's hierarchical preference list.

10. A method of implementing a computerized matching system for assignment of players to teams within a professional sports league, said method comprising the steps of:
a. providing league comprising a plurality of teams and a plurality of players;
b. providing a computerized match system comprising a central server accessible via one or more web interfaces over the Internet or an intranet, said central server comprising one or more system servers, including a web server;
c. loading a hierarchical tiered salary structure, with predetermined salaries for each tier and predetermined numbers of players at each tier, into a database that is stored on said central server or on a separate database server in communication with said central server;
d. a player submitting to said computerized match system, via a player computerized system interface in communication with said central server via one of said web interfaces,
a rank order of teams in a league in order of said player's preference, said rank order stored into a database that is stored on said central server;
e. a team submitting to said computerized match system, via a team computerized system interface in communication with said central server via one of said web interfaces, an initial selection of players for a first tier, said initial selection of players for a first tier stored into a database that is stored on said central server;
f. running match algorithm processes via computerized match system computer code on the central server to prioritize a match between a selected player and a selecting team based upon criteria comprising:
whether said selected player is a member of said selecting team, and
the rank position of said team within said selected player's rank order;
g. running computerized match system computer code to move a player from a first matched team to a subsequently selecting higher ranked team upon said higher ranked team's selection of said player;
h. said first matched team submitting an alternate player via said team computerized system interface in communication with said central server via one of said web interfaces to fill the team position vacancy created by said player movement to a higher ranked team; and
i. repeating steps d through h for each team in said league until all first tier team positions are filled.

11. A method of implementing a computerized matching system for assignment of players to teams within a professional sports league, said method comprising the steps of:
a. providing a computerized match system comprising:
i. one or more web interfaces, each presenting a graphic user interface via a web browser;
ii. a central server accessible via said web interfaces over the Internet;
iii. said central server comprising one or more computer processors;
iv. said central server comprising a web server, a database server and at least one database for storing data provided to the database in database tables;
v. computer code for running a match algorithm on a computer processor of said central server;
b. storing a hierarchical tiered salary structure in said database, said hierarchical tiered salary structure including predetermined salaries for each of a plurality of tiers;
c. storing a player rank order of teams in said database;
d. storing a team initial selection of players for tier in said database; and
e. prioritizing a match between a selected player and a selecting team by running match algorithm computer code on said central server, said match algorithm computer code prioritizing matches according to:
i. tier level,
ii. current team status,
iii. rank order status.
